(19) United States
(12) Patent Application Publication
(10) Pub. No.: US 2009/0306147 A1
(43) Pub. Date: Dec. 10, 2009

(54) BIOLOGICAL EFFICACY OF AGROCHEMICAL COMPOSITIONS ON APPLICATION IN THE GROWTH SUBSTRATE SUITABLE FORMULATIONS AND USE THEREOF

(75) Inventors: Peter Marczok, Koln (DE); Peter Baur, Schondorf (DE); Ronald Vermeer, Leverkusen (DE); Wolfgang Thielert, Odenthal (DE); Heike Hungenberg, Langenfeld (DE); Kai-Uwe Brueggen, Mumbai (IN); Dirk Ebbinghaus, Wuppertal (DE); Peter Losel, Leverkusen (DE); Udo Reckmann, Koln (DE)

Correspondence Address: Baker Donelson Bearman, Caldwell & Berkowitz, PC, 555 Eleventh Street, NW, Sixth Floor, Washington, DC, 20004, US

(73) Assignee: Bayer CropScience AG, Monheim (DE)

(21) Appl. No.: 12/443,290

(22) PCT Filed: Sep. 18, 2007
(86) PCT No.: PCT/EP07/08095

§ 371 Date: Jul. 21, 2009

(30) Foreign Application Priority Data
Sep. 30, 2006 (EP) 06020675.2

(51) Int. Cl. A01N 43/40; A01N 43/56; A01N 43/38

(52) U.S. Cl. 514/341; 514/407; 514/409

(57) ABSTRACT

In soil applications, the action of crop protection compositions comprising active compounds from the classes of the neonicotinoids, the pyrethroids, the butenolides, the ketoenols, the phenylpyrazoles or the fungicides can be improved by adjuvants. The present invention describes corresponding methods and suitable compositions.

The present invention relates to the improvement of the action of agrochemical compositions in soil applications, to agrochemical compositions suitable for this application and to their use for controlling harmful insects or phytopathogenic fungi.

For controlling harmful organisms, agrochemically active compounds can be applied by various means. In addition to foliar treatment, it is also possible to treat the culture substrate. This may be soil, but also special substrates based, inter alia, on peat mosses, coco fibres, stone wool, such as, for example, Grodan®, pummis, expanded clay, such as, for example Lecaton® or Lecadan®, clay granules, such as, for example, Seramis®, foamed plastics, such as, for example, Baystrat®, vermiculite, perlite, synthetic soils, such as, for example, Hygromull®, or combinations of these substrates. Hereinbelow, all these culture substrates are referred as soil. By applying active compounds in or onto the soil, soil-dwelling harmful organisms are brought into contact with the active compound, and the uptake of systemic active compounds by the roots is initiated. Various auxiliaries for improving the action of agrochemically active compounds in foliar treatment are already known. These include, for example, penetrants which facilitate the penetration of the active compounds into the plants (for example WO 03/000053). For soil applications of insecticides and fungicides, corresponding adjuvants have hitherto not been described. What is known is the effect of soil penetration aids which accelerate the penetration of irrigation water into dry soils (for example Agri-Prep® CS from Northwest Agricultural Products).

It is also known that surfactants may have an effect on the distribution of permethrin in the soil (Howell, McMullan P. M. (ed.), 1998, Adjuvants for Agrochemicals, Proceedings of the 5th international Symposium on Adjuvants for Agrochemicals, Memphis, USA, pp. 247-253).

Improvements of herbicidal compositions by optimized formulations have also been described (Chung et al., Pesticide Science, 1993, 38(2-3), pp. 250-252).

Surprisingly, it has now been found that the biological action of insecticidal and fungicidal compositions in soil applications can be improved when these compositions comprise an adjuvant. Here, the adjuvant may either already be a component of the concentrated formulation (in-can formulation), or it may be added during the preparation of the ready-to-use pesticide solution (tank mix application). The improved action is evident both in the control of soil organisms and in the control of foliar pests or foliar diseases controlled by the systemic active compounds. In this manner, using the compositions according to the invention, it is possible to decrease the amount of active compound applied or, at an unchanged application rate, to achieve improved action. Additionally, it is possible to reduce water consumption to a minimum.

Accordingly, the present invention provides use of adjuvants for improving the action of agrochemical compositions in soil applications, for example by spraying onto the soil, watering, side-dressing, shower drenching, overhead drenching or application using an irrigation system (drip irrigation).

The present invention now provides novel suspension concentrates for this application comprising
at least one agrochemically active compound from the group of the insecticides or fungicides which is solid at room temperature,
at least one adjuvant.

In addition to concentrated formulations, the invention also provides dilute ready-to-use compositions. The invention furthermore provides the use of these compositions for controlling harmful organisms in the soil, foliar pests and phytopathogenic fungi.

In the context of the present invention, an adjuvant is a substance which, in the test system described below, improves the biological action:

Young maize plants are planted into 1 litre vessels with soil (sandy loam soil, humidity 10% by weight, pH 6.7). The plants are grown in a greenhouse at 20° C. for 3 or 12 days (until they have reached the 2- or 3-leaf stage) before they are watered. During watering, 0.25 mg or 0.5 mg of the insecticidally active compound (S)-3-chloro-N¹-{2-methyl-4-[1,2,2,2-tetrafluoro-1-(trifluoromethyl)ethyl]phenyl}-N²-(1-methyl-2-methylsulphonylethyl)phthalamide (known from WO 06/22225) and 60 mg of potential adjuvant are applied in a watering volume of 60 ml. 1, 3, 7 or 14 days after watering, the plants are infected by populating them with larvae of the L2 stage of Spodoptera frugiperda, and the mortality of the larvae is determined in each case after 7 days. As a control, the same test is carried out without addition of a potential adjuvant. When the adjuvants according to the invention are used, this test shows a mortality which is increased compared to that of the control. Here, the mortality is not necessarily increased at each point of time, it may also be that only the initial activity or the long-term activity is improved.

Adjuvants according to the invention which may be mentioned as examples are in particular the following substances and compositions:
(I-1) dioctyl sodium sulphosuccinate, commercially available, for example, in the product series Geropon®,
(I-2) compositions comprising dioctyl sodium sulphosuccinate and sodium benzoate, commercially available, for example, in the product series Aerosol®; the weight ratio of dioctyl sodium sulphosuccinate:sodium benzoate is preferably from 5:1 to 6:1,
(I-3) terminally capped alkoxylated fatty alcohols and terminally capped alkoxylated straight-chain alcohols, commercially available, for example, in the product series Plurafac®; preference is given to ethoxylated and/or butoxylated fatty alcohols and terminally capped ethoxylated and/or butoxylated straight-chain alcohols,
(I-4) tributylphenol polyglycol ethers having 10 to 15 EO units (where EO means ethylene oxide), commercially available, for example, in the product series Sapogenat®,
(I-5) polyalkylene oxide-modified polymethylsiloxanes, commercially available, for example, in the product series Silwet®,
(I-6) branched alkanol alkoxylates of the formula CH₃—(CH₂)ₜ—CH₂—O—(—CH₂—CH₂—O—)ᵤ—H, in which t represents numbers from 9 to 10.5 and u represents numbers from 6 to 25 (preferably from 8 to 12) and t and u are average values, commercially available, for example, in the product series Lutensol®,
(I-7) betaine,
(I-8) polyalkoxylated triglycerides, where the triglyceride is preferably of vegetable origin, commercially available, for example, in the product series Crovol®,
(I-9) alkoxylated fatty amines, commercially available, for example, in the product series Armoblen®,
(I-10) sodium laureth sulphate, commercially available, for example, in the product series Genapol®,
(I-11) PEG-10 coconut alcohol, commercially available, for example, in the product series Genapol®,
(I-12) compositions comprising maize syrup, petroleum oil and nonionic emulsifier, commercially available, for example, in the product series Superb®.

In principle, the advantageous effect of these adjuvants applies to all insecticidal agrochemically active compounds, but especially to active compounds from the classes of the neonicotinoids, the pyrethroids, the butenolides, the ketoenols, the fiproles, the anthranilamides, the mectins, the spinosyns, the organophosphates and the carbamates. Neonicotinoids can be described by the formula (II),

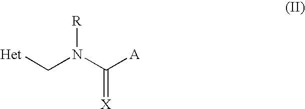

in which
Het represents a heterocycle selected from the following group of heterocycles: 2-chloropyrid-5-yl, 2-methylpyrid-5-yl, 1-oxido-3-pyridinio, 2-chloro-1-oxido-5-pyridinio, 2,3-dichloro-1-oxido-5-pyridinio, tetrahydrofuran-3-yl, 5-methyltetrahydrofuran-3-yl, 2-chlorothiazol-5-yl,
R represents hydrogen, C₁-C₆-alkyl, C₂-C₆-alkenyl, C₂-C₆-alkynyl, —C(═O)—CH₃ or benzyl or together with R² represents one of the group below: —CH₂—CH₂—, —CH₂—CH₂—CH₂—, —CH₂—O—CH₂—, —CH₂—S—CH₂—, —CH₂—NH—CH₂—, —CH₂—N(CH₃)—CH₂— and
X represents N—NO₂, N—CN or CH—NO₂,
A represents methyl, —N(R¹)(R²) or S(R²),
in which
   R¹ represents hydrogen, C₁-C₆-alkyl, phenyl-C₁-C₄-alkyl, C₃-C₆-cycloalkyl, C₂-C₆-alkenyl or C₂-C₆-alkynyl, and
   R² represents C₁-C₆-alkyl, C₂-C₆-alkenyl, C₂-C₆-alkynyl, —C(═O)—CH₃ or benzyl,

(see, for example, EP-A1-192 606, EP-A 2-580 533, EP-A 2-376 279, EP-A 2-235 725). Specific mention may be made of the following compounds (II-1) to (II-7) from the class of the neonicotinoids:
thiamethoxam (II-1) has the formula

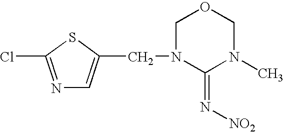

and is known from EP A2 0 580 553.
clothianidin (II-2) has the formula

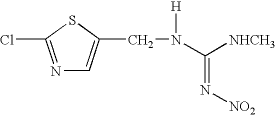

and is known from EP A2 0 376 279.
thiacloprid (II-3) has the formula

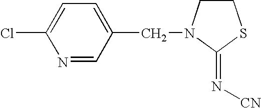

and is known from EP A2 0 235 725.
dinotefuran (II-4) has the formula

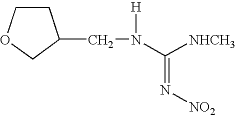

and is known from EP A1 0 649 845.
acetamiprid (II-5) has the formula

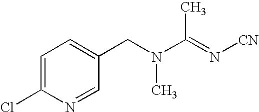

and is known from WO A1 91/04965.
nitenpyram (II-6) has the formula

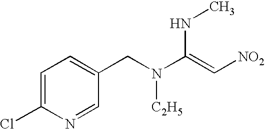

and is known from EP-A 0 302 389.
imidacloprid (II-7) has the formula

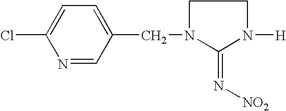

and is known from EP-A 0 192 060.

The insecticidally active compounds from the class of the pyrethroids which can be used according to the invention include, for example, substances (III-1) to (III-24):
(III-1) acrinathrin

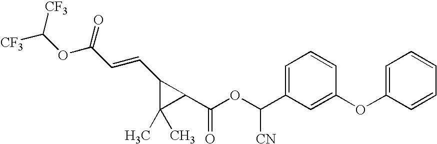

known from EP-A-048 186,
(III-2) alpha-cypermethrin

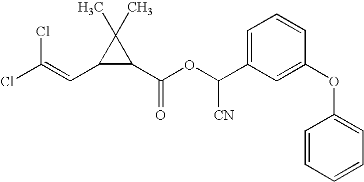

known from EP-A-067 461
(III-3) betacyfluthrin

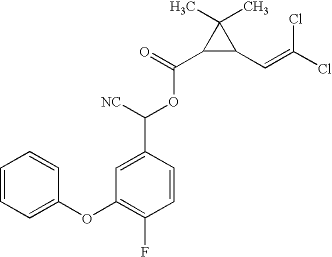

known from EP-A-206 149,
(III-4) gamma-cyhalothrin

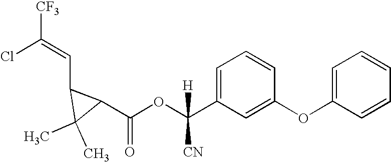

known from DE-A-2 802 962,
(III-5) cypermethrin

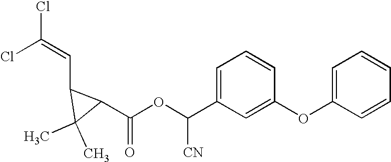

known from DE-A-2 326 077,
(III-6) deltamethrin

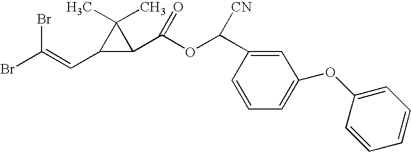

known from DE-A-2 326 077,
(III-7) esfenvalerate

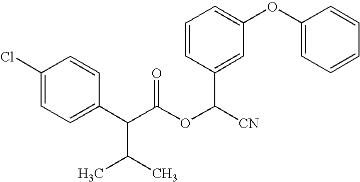

known from DE-A-2 737 297,
(III-8) ethofenprox

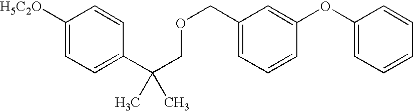

known from DE-A-3 117 510,
(III-9) fenpropathrin

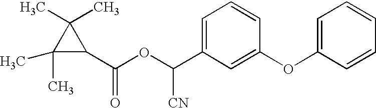

known from DE-A-2 231 312,
(III-10) fenvalerate

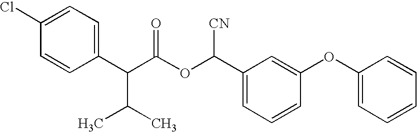

known from DE-A-2 335 347,
(III-11) flucythrinate

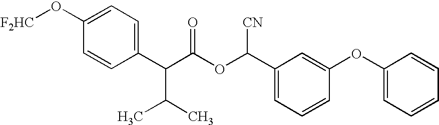

known from DE-A-2 757 066,
(III-12) lambda-cyhalothrin

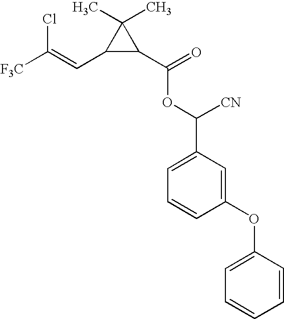

known from EP-A-106 469,
(III-13) permethrin

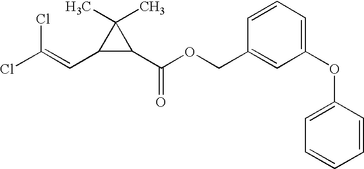

known from DE-A-2 326 077,
(III-14) taufluvalinate

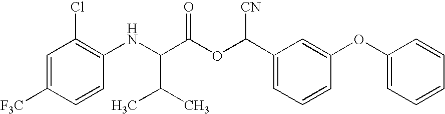

known from EP-A-038 617,
(III-15) tralomethrin

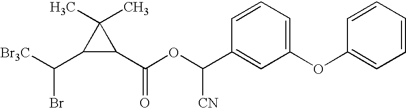

known from DE-A-2 742 546,
(III-16) zeta-cypermethrin

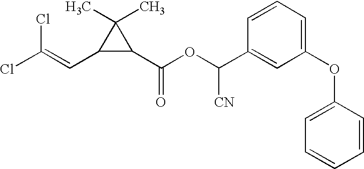

known from EP-A-026 542,
(III-17) cyfluthrin

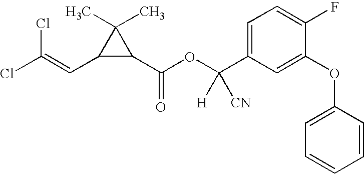

known from DE-A-27 09 264,
(III-18) bifenthrin

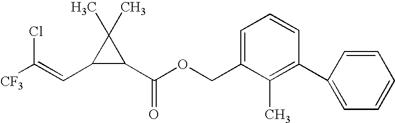

known from EP-A-049 977,
(III-19) cycloprothrin

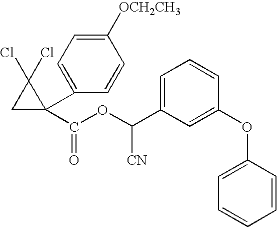

known from DE-A-2653189,
(III-20) eflusilanate

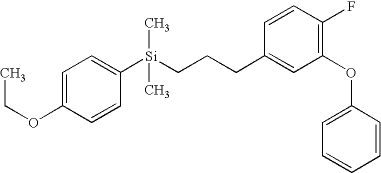

known from DE-A-36 04 781,
(III-21) fubfenprox

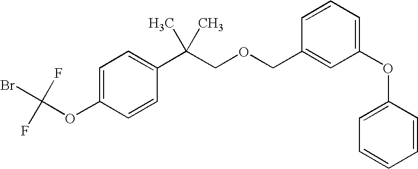

known from DE-A-37 08 231,
(III-22) pyrethrin

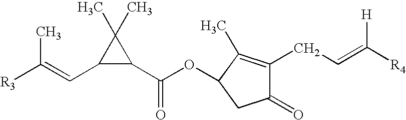

R₃=—CH₃ or —CO₂CH₃
R₄=—CH═CH₂ or —CH₃ or —CH₂CH₃
known from The Pesticide Manual, 1997, 11th Edition p. 1056,
(III-23) resmethrin

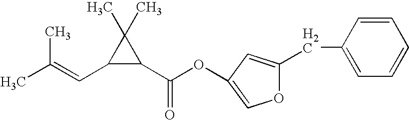

known from GB-A-1 168 797, and
(III-24) tefluthrin

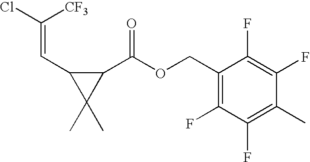

known from EP-A1 31 199

The formula (IV) provides a general definition of the insecticidally active compounds from the class of the butenolides (known from EP-A 0 539 588) which can be used according to the invention:

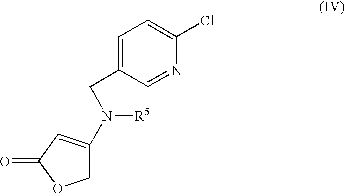

where
R⁵ represents methyl or cyclopropyl.

Specific mention may be made of the compounds (IV-1) and (IV-2).

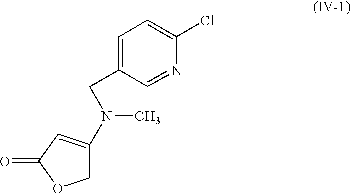

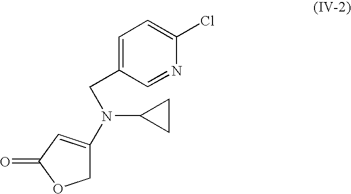

The formula (V) provides a general definition of the insecticidally active compounds from the class of the ketoenols (known from EP-A 0 539 588) which can be used according to the invention:

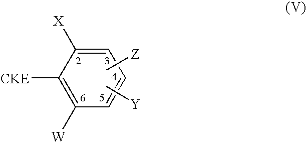

in which
W represents hydrogen, alkyl, alkenyl, alkynyl, halogen, alkoxy, halogenalkyl, halogenalkoxy or cyano,
X represents halogen, alkyl, alkenyl, alkynyl, alkoxy, alkoxyalkoxy, halogenalkyl, halogenalkoxy or cyano,
Y represents hydrogen, halogen, alkyl, alkenyl, alkynyl, alkoxy, cyano, halogenalkyl, halogenalkoxy or represents in each case optionally substituted phenyl or hetaryl,
Z represents hydrogen, halogen, alkyl, halogenalkyl, cyano, alkoxy or halogenalkoxy,
CKE represents one of the groups

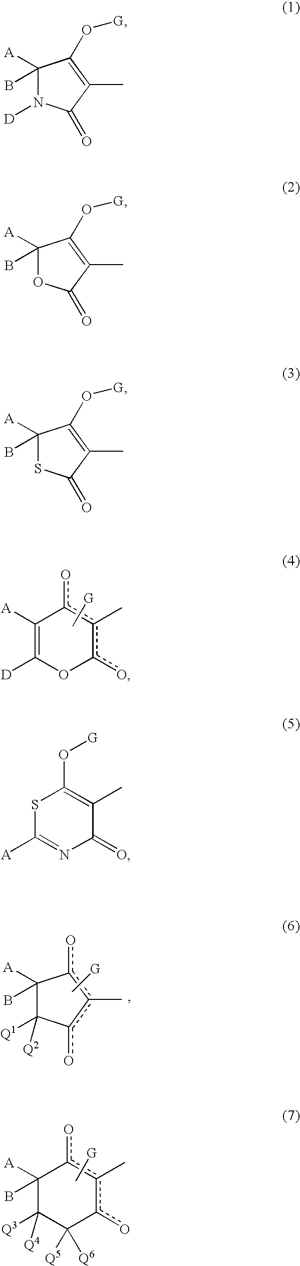

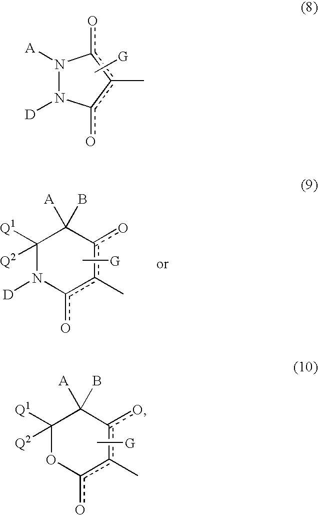

in which
A represents hydrogen, represents in each case optionally halogen-substituted alkyl, alkenyl, alkoxyalkyl, alkylthioalkyl, saturated or unsaturated, optionally substituted cycloalkyl in which optionally at least one ring atom is replaced by a heteroatom, or in each case optionally by halogen-, alkyl-, halogenalkyl-, alkoxy-, halogenalkoxy-, cyano- or nitro-substituted aryl, arylalkyl or hetaryl,
B represents hydrogen, alkyl or alkoxyalkyl, or
A and B together with the carbon atom to which they are attached represent a saturated or unsaturated unsubstituted or substituted cycle which optionally contains at least one heteroatom,
D represents hydrogen or an optionally substituted radical from the group consisting of alkyl, alkenyl, alkynyl, alkoxyalkyl, saturated or unsaturated cycloalkyl in which optionally one or more ring members are replaced by heteroatoms, arylalkyl, aryl, hetarylalkyl or hetaryl or
A and D together with the atoms to which they are attached represent a saturated or unsaturated cycle which is unsubstituted or substituted in the A, D moiety and optionally contains at least one (in the case of CKE-8 further) heteroatom, or
A and Q¹ together represent alkanediyl or alkenediyl, optionally substituted by hydroxyl and/or in each case optionally substituted alkyl, alkoxy, alkylthio, cycloalkyl, benzyloxy or aryl, or
D and Q¹ together with the atoms to which they are attached represent a saturated or unsaturated cycle which is unsubstituted or substituted in the D, Q¹ moiety and optionally contains at least one heteroatom,
Q¹ represents hydrogen, alkyl, alkoxyalkyl, optionally substituted cycloalkyl (in which optionally one methylene group is replaced by oxygen or sulphur) or optionally substituted phenyl,
Q², Q⁴, Q⁵ and Q⁶ independently of one another represent hydrogen or alkyl,
Q³ represents hydrogen, represents optionally substituted alkyl, alkoxyalkyl, alkylthioalkyl, optionally substituted cycloalkyl (in which optionally one methylene group is replaced by oxygen or sulphur) or optionally substituted phenyl, or
Q¹ and Q² together with the carbon atom to which they are attached represent an unsubstituted or substituted cycle which optionally contains a heteroatom, or
Q³ and Q⁴ together with the carbon atom to which they are attached represent a saturated or unsaturated unsubstituted or substituted cycle which optionally contains a heteroatom,
G represents hydrogen (a) or represents one of the groups

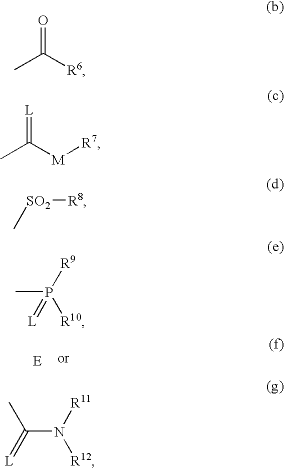

in which
E represents a metal ion equivalent or an ammonium ion,
L represents oxygen or sulphur,
M represents oxygen or sulphur,
R⁶ represents in each case optionally halogen-substituted alkyl, alkenyl, alkoxyalkyl, alkylthioalkyl, polyalkoxyalkyl or optionally halogen-, alkyl or alkoxy-substituted cycloalkyl which may be interrupted by at least one heteroatom, in each case optionally substituted phenyl, phenylalkyl, hetaryl, phenoxyalkyl or hetaryloxyalkyl,
R⁷ represents in each case optionally halogen-substituted alkyl, alkenyl, alkoxyalkyl, polyalkoxyalkyl or represents in each case optionally substituted cycloalkyl, phenyl or benzyl,
R⁸, R⁹ and R¹⁰ independently of one another represent in each case optionally halogen-substituted alkyl, alkoxy, alkylamino, dialkylamino, alkylthio, alkenylthio, cycloalkylthio or represent in each case optionally substituted diphenyl, benzyl, phenoxy or phenylthio,
R¹¹ and R¹² independently of one another represent hydrogen, in which case optionally halogen-substituted alkyl, cycloalkyl, alkenyl, alkoxy, alkoxyalkyl, represent optionally substituted phenyl, represent optionally substituted benzyl, or together with the nitrogen atom to which they are attached represent a cycle which is optionally interrupted by oxygen or sulphur.

Specific mention may be made of the compounds (V-1) to (V-5):

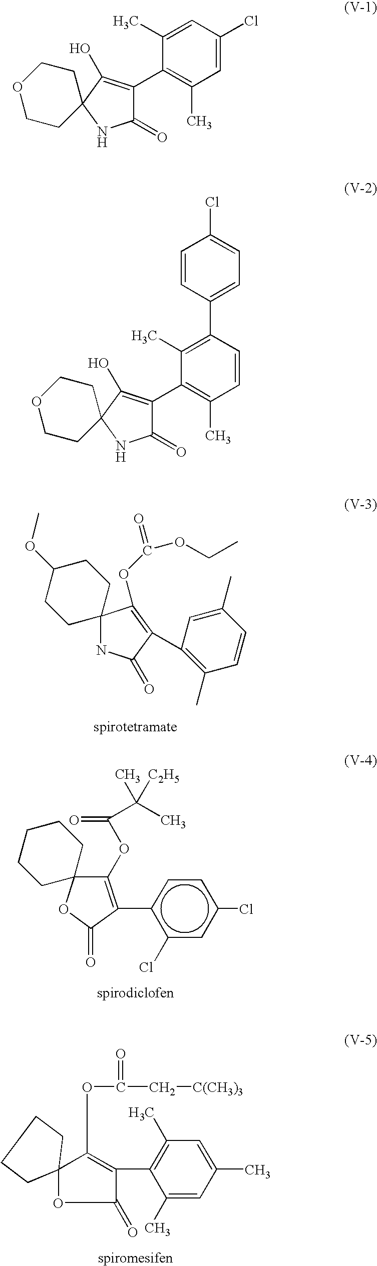

Insecticidally active compounds from the class of the fiproles which may be used according to the invention are fipronil (VI-1) and ethiprole (VI-2).

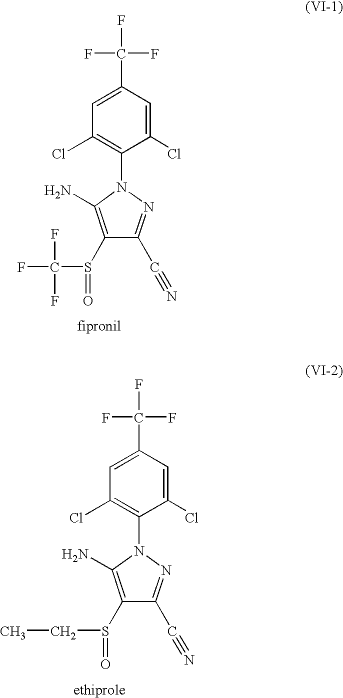

Insecticidally active compounds from the class of the anthranilamides which may used according to the invention are, for example, (VII-1) to (VII-23)

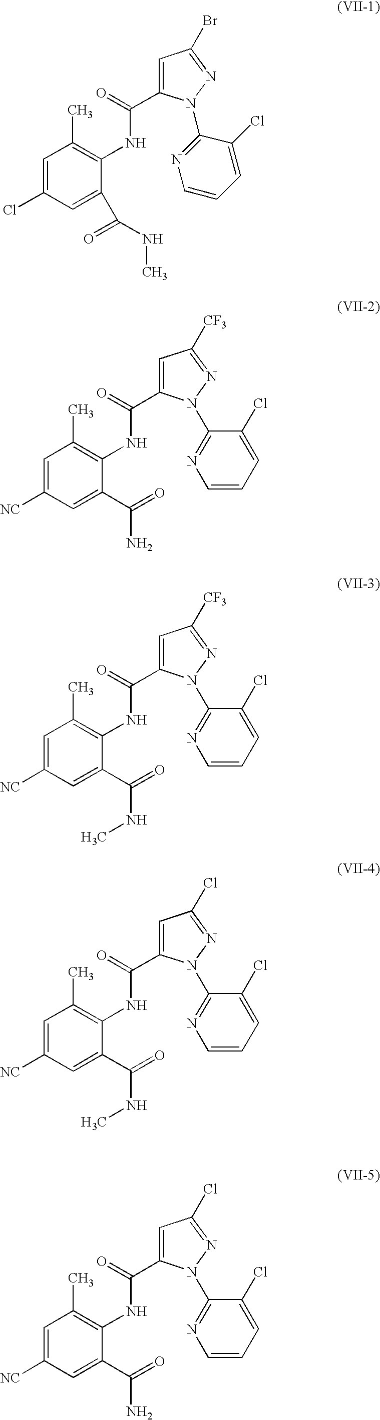

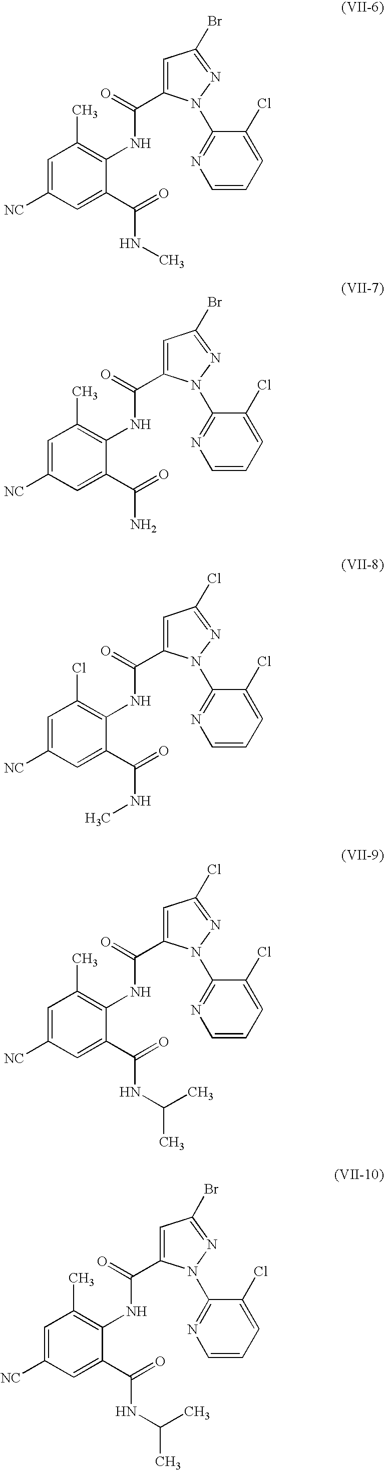

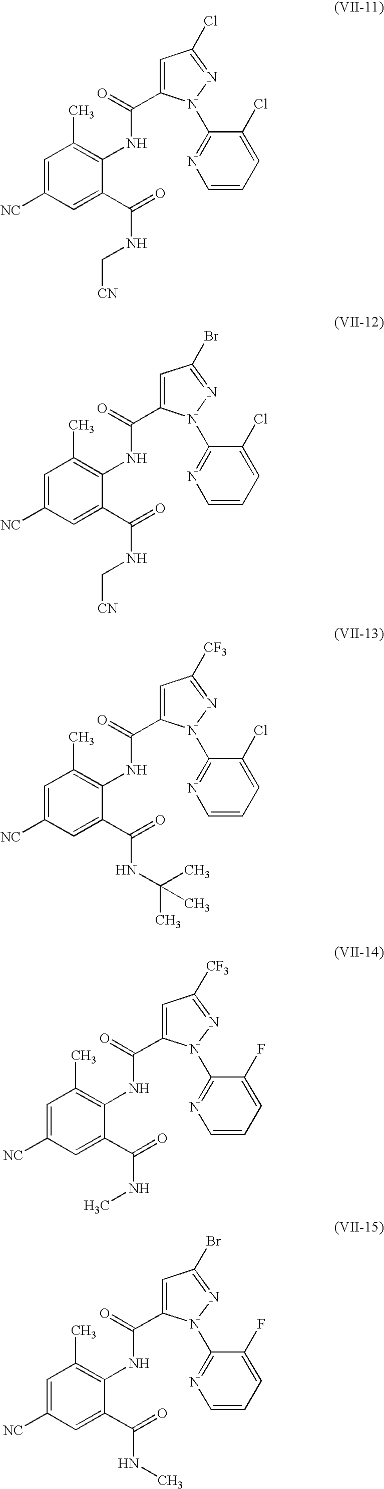

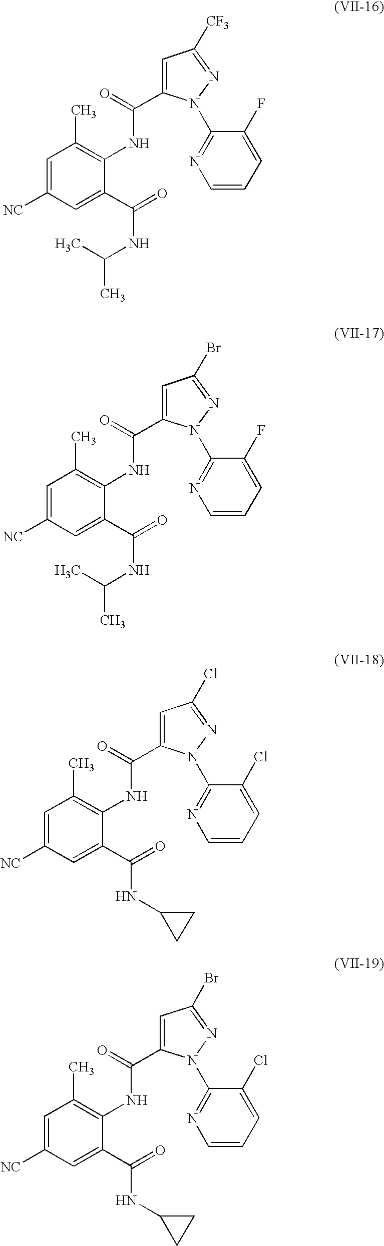

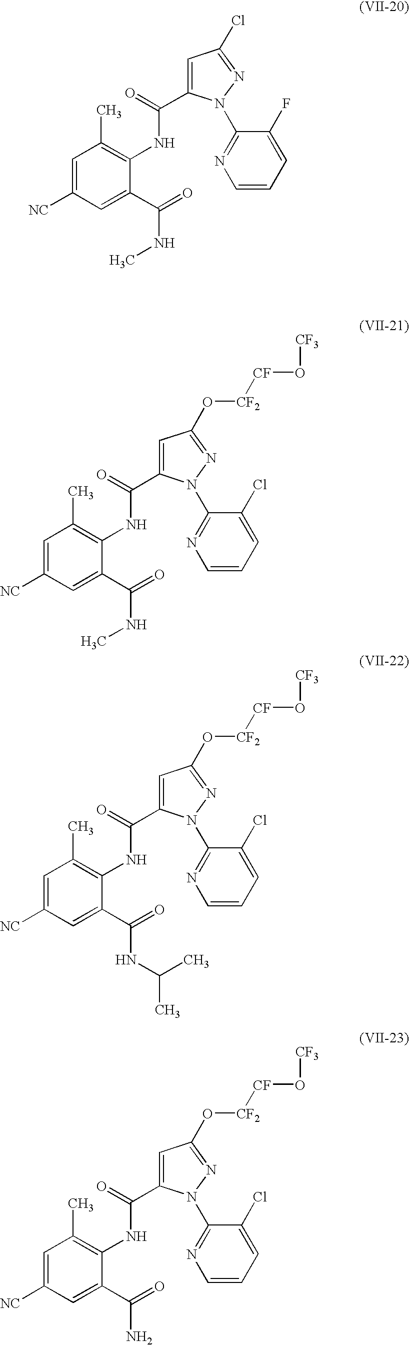

Insecticidally active compounds from the class of the mectins which may be used according to the invention are, for example,

(VIII-1) abamectin

(VIII-2) emamectin

(VIII-3) emamectin-benzoate

(VIII-4) ivermectin

(VIII-5) lepimectin

(VIII-6) milbemycin.

An insecticidally active compound from the class of the spinosynes which may be used according to the invention is, for example,

(IX-1) spinosad.

Insecticidally active compounds from the class of the organophosphates which may be used according to the invention are, for example, acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, chlorofenvinphos, demeton-S-methyl, demeton-S-methylsulphone, dialifos, diazinon, dichlofenthion, dichlorvos/DDVP, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorovinphos, thiometon, triazophos, triclorofon and vamidothion, preferably

(X-1) chloropyrifos (-methyl/-ethyl),

(X-2) cadusafos,

(X-3) acephate,

(X-4) fenamiphos

(X-5) fosthiazate and

(X-6) ethoprofos.

Insecticidally active compounds from the class of the carbamates which may be used according to the invention are, for example, alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulfan, cloethocarb, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, trimethacarb, XMC, xylylcarb and triazamate, preferably

(XI-1) carbofuran,

(XI-2) aldicarb and

(XI-3) oxamyl.

The abovementioned compounds from the classes of neonicotinoids, butenolides and ketoenols are particularly advantageous active compounds according to the invention.

In principle, the advantageous effect of these adjuvants also applies to all systemic fungicidal agrochemically active compounds. Fungicidal active compounds which may be used according to the invention are, for example:

Inhibitors of nucleic acid synthesis
benalaxyl, benalaxyl-M, bupirimate, chiralaxyl, clozylacon, dimethirimol, ethirimol, furalaxyl, hymexazol, mefenoxam, metalaxyl, metalaxyl-M, ofurace, oxadixyl, oxolinic acid

Inhibitors of mitosis and cell division
benomyl, carbendazim, diethofencarb, fuberidazole, thiabendazole, thiophanate-methyl

Inhibitors of respiratory chain complex II
boscalid, carboxin, fenfuram, flutolanil, furametpyr, furmecyclox, mepronil, oxycarboxin

Inhibitors of respiratory chain complex III
azoxystrobin, cyazofamid, dimoxystrobin, enestrobin, famoxadone, fenamidone, fluoxastrobin, kresoxim-methyl, metominostrobin, orysastrobin, pyraclostrobin, picoxystrobin, trifloxystrobin

Inhibitors of ATP production
fentin acetate, fentin chloride, fentin hydroxide

Inhibitors of amino acid biosynthesis and protein biosynthesis
andoprim, cyprodinil, kasugamycin, kasugamycin hydrochloride hydrate, pyrimethanil

Inhibitors of signal transduction
fludioxonil, quinoxyfen

Inhibitors of lipid and membrane synthesis
chlozolinate, iprodione, procymidone
ampropylfos, potassium-ampropylfos, edifenphos, etridiazole, iprobenfos (IBP), isoprothiolane, pyrazophos
biphenyl
iodocarb, propamocarb, propamocarb hydrochloride, propamocarb-fosetylate

Inhibitors of ergosterol biosynthesis
azaconazole, bitertanol, bromuconazole, cyproconazole, diclobutrazole, difenoconazole, diniconazole, diniconazole-M, epoxiconazole, etaconazole, fenarimol, fenbuconazole, fluquinconazole, flurprimidole, flusilazole, flutriafol, furconazole, furconazole-cis, hexaconazole, imazalil, imazalil sulphate, imibenconazole, ipconazole, metconazole, myclobutanil, nuarimol, oxpoconazole, paclobutrazole, penconazole, pefurazoate, prochloraz, propiconazole, prothioconazole, pyrifenox, simeconazole, tebuconazole, tetraconazole, triadimefon, triadimenol, triflumizole, triforine, triticonazole, uniconazole, voriconazole, viniconazole,
aldimorph, dodemorph, dodemorph acetate, fenpropidin, fenpropimorph,
spiroxamine, tridemorph,
naftifine, pyributicarb, terbinafine

Inhibitors of cell wall synthesis
benthiavalicarb, bialaphos, dimethomorph, flumorph, iprovalicarb, mandipropamid, polyoxins, polyoxorim

Inhibitors of melanin biosynthesis
capropamid, diclocymet, fenoxanil, phthalid, pyroquilon, tricyclazole

Resistance inductors
acibenzolar-S-methyl, probenazole, tiadinil

Further fungicides
amibromdol, benthiazole, bethoxazin, capsimycin, carvone, chloropicrin, cufraneb, cymoxanil, dazomet, debacarb, diclomezine, difenzoquat, difenzoquat metilsulphate, dimetomorph, dithiofencarb, ferimzone, flumetover, flusulfamide, fluopicolide, fluoroimide, fosetyl-aluminum, fosetyl-calcium, fosetyl-sodium, hexachlorobenzene, 8-hydroxyquinoline sulphate, irumamycin, methasulfocarb, metrafenone, methyl isothiocyanate, mildiomycin, natamycin, nickel dimethyl dithiocarbamate, octhilinone, oxamocarb, oxyfenthiin, pentachlorophenol and salts, 2-phenylphenol and salts, piperalin, propanosine-sodium, pyribencarb, pyrrolnitrin, quintozene, tecloftalam, tecnazene, trichlamide, valiphenal, zarilamid,
2-(2-{[6-(3-chloro-2-methylphenoxy)-5-fluoropyrimidin-4-yl]oxy}phenyl)-2-(methoxyimino)-N-methylacetamide,
2-[[[[1-[3-(1-fluoro-2-phenylethyl)oxy]phenyl]ethylidene]amino]oxy]methyl]-alpha-(methoxyimino)-N-methyl-alpha-benzacetamide,
cis-1-(4-chlorophenyl)-2-(1H-1,2,4-triazol-1-yl)cycloheptanol,
1-[(4-methoxyphenoxy)methyl]-2,2-dimethylpropyl-1H-imidazole-1-carboxylic acid,
2,3,5,6-tetrachloro-4-(methylsulphonyl)pyridine,
2-butoxy-6-iodo-3-propylbenzopyranon-4-one,
2-chloro-N-(2,3-dihydro-1,1,3-trimethyl-1H-inden-4-yl)-3-pyridinecarboxamide,
3,4,5-trichloro-2,6-pyridinedicarbonitrile,
3,4-dichloro-N-(2-cyanophenyl)isothiazole-5-carboxamide (isotianil)
3-[5-(4-chlorophenyl)-2,3-dimethylisoxazolidin-3-yl]pyridine,
5-chloro-6-(2,4,6-trifluorophenyl)-N-[(1R)-1,2,2-trimethylpropyl][1,2,4]triazolo[1,5-a]pyrimidine-7-amine,
5-chloro-7-(4-methylpiperidin-1-yl)-6-(2,4,6-trifluorophenyl)[1,2,4]triazolo[1,5-a]pyrimidine,
5-chloro-N-[(1R)-1,2-dimethylpropyl]-6-(2,4,6-trifluorophenyl)[1,2,4]triazolo[1,5-a]pyrimidine-7-amine,
methyl 2-[[[cyclopropyl[(4-methoxyphenyl)imino]methyl]thio]methyl]-alpha-(methoxymethylene) benzacetate,
methyl 1-(2,3-dihydro-2,2-dimethyl-1H-inden-1-yl)-1H-imidazole-5-carboxylate,
N-(3′,4′-dichloro-5-fluorobiphenyl-2-yl)-3-(difluoromethyl)-1-methyl-1H-pyrazole-4-carboxamide,
N-(3-ethyl-3,5,5-trimethylcyclohexyl)-3-formylamino-2-hydroxy benzamide,
N-(4-chloro-2-nitrophenyl)-N-ethyl-4-methylbenzenesulphonamide,
N-(4-chlorobenzyl)-3-[3-methoxy-4-(prop-2-yn-1-yloxy)phenyl]propanamide,
N-[(4-chlorophenyl)(cyano)methyl]-3-[3-methoxy-4-(prop-2-yn-1-yloxy)phenyl]propanamide,
N-(5-bromo-3-chloropyridin-2-yl)methyl-2,4-dichloronicotinamide,
N-[1-(5-bromo-3-chloropyridin-2-yl)ethyl]-2,4-dichloronicotinamide,
(2S)-N-[2-[4-[[3-(4-chlorophenyl)-2-propynyl]oxy]-3-methoxyphenyl]ethyl]-3-methyl-2-[(methylsulphonyl)amino]butanamide,
N-{(Z)-[(cyclopropylmethoxy)imino][6-(difluoromethoxy)-2,3-difluorophenyl]methyl}-2-benzacetamide,
N-{2-[1,1′-bi(cyclopropyl)-2-yl]phenyl}-3-(difluoromethyl)-1-methyl-1H-pyrazole-4-carboxamide,
N-{2-[3-chloro-5-(trifluoromethyl)pyridin-2-yl]ethyl}-2-(trifluoromethyl)benzamide,
N-ethyl-N-methyl-N′-{2-methyl-5-(trifluoromethyl)-4-[3-(trimethylsilyl)propoxy]phenyl}imidoformamide,
O-[1-[(4-methoxyphenoxy)methyl]-2,2-dimethylpropyl]-1H-imidazole-1-carbothioic acid,
2-amino-4-methyl-N-phenyl-5-thiazolecarboxamide,
2,4-dihydro-5-methoxy-2-methyl-4-[[[[1-[3-(trifluoromethyl)phenyl]ethylidene]amino]oxy]methyl]phenyl]-3H-1,2,4-triazol-3-one (CAS No. 185336-79-2) and
N-(6-methoxy-3-pyridinyl)cyclopropane carboxamide.

Fungicides which may preferably be used according to the invention are etridiazole, fosetyl-aluminum, propamocarb hydrochloride, metalaxyl, metalaxyl-M, benalaxyl-M, azoxystrobin, dimetomorph, pyrimethanil, carbendazim, dithiofencarb, thiophanate-methyl, prochloraz, boscalid, trifloxystrobin, fluoxastrobin, iprodione, propamocarb fosetylate, prothioconazole, triticonazole, fluquinconazole, triadimenol, iprovalicarb, fluopicolide, N-{2-[1,1′-bi(cyclopropyl)-2-yl]phenyl}-3-(difluoromethyl)-1-methyl-1H-pyrazole-4-carboxamide, N-[2-(1,3-dimethylbutyl)phenyl]-5-fluoro-1,3-dimethyl-1H-pyrazole-4-carboxamide, N-(3′,4′-dichloro-5-fluoro-1,1′-biphenyl-2-yl)-3-(difluoromethyl)-1-methyl-1H-pyrazol-4-carboxamide, N-{2-[3-chloro-5-(trifluoromethyl)-2-pyridinyl]ethyl}-2-trifluoromethylbenzamide, 5-chloro-6-(2,4,6-trifluorophenyl)-N-[(1R)-1,2,2-trimethylpropyl][1,2,4]triazolo[1,5-a]pyrimidine-7-amine, 5-chloro-N-[(1R)-1,2-dimethylpropyl]-6-(2,4,6-trifluorophenyl)[1,2,4]triazolo[1,5-a]pyrimidine-7-amine and 5-chloro-7-(4-methylpiperidin-1-yl)-6-(2,4,6-trifluorophenyl)[1,2,4]triazolo[1,5-a]pyrimidine.

In addition to at least one active compound and at least one adjuvant, the compositions according to the invention may preferably furthermore comprise further formulation auxiliaries:
at least one nonionic surfactant and/or at least one anionic surfactant and
one or more additives from the groups of the antifreeze agents, the antifoams, the preservatives, the antioxidants, the spreading agents, the colorants and/or the thickeners.

Examples of further ingredients of the formulations according to the invention which may be mentioned are, in particular, the following substances:

Suitable nonionic surfactants are all compounds of this type which are usually employed in agrochemical compositions. Polyethylene oxide/polypropylene oxide block copolymers, polyethylene glycol ethers of straight-chain alcohols, reaction products of fatty acids with ethylene oxide and/or propylene oxide, furthermore polyvinyl alcohol, polyvinylpyrrolidone, mixed polymers of polyvinyl alcohol and polyvinylpyrrolidone, mixed polymers of polyvinyl acetate and polyvinylpyrrolidone and also copolymers of (meth)acrylic acid and (meth)acrylic esters, furthermore alkyl ethoxylates and alkylaryl ethoxylates which may optionally be phosphated and may optionally be neutralized with bases, polyoxyamine derivatives and nonylphenol ethoxylates may be mentioned as being preferred.

Suitable anionic surfactants are all substances of this type which are usually employed in agrochemical compositions. Preference is given to alkali metal and alkaline earth metal salts of alkylsulphonic acids or alkylarylsulphonic acids.

A further preferred group of anionic surfactants or dispersants are salts of polystyrenesulphonic acids, salts of polyvinylsulphonic acids, salts of naphthalenesulphonic acid/formaldehyde condensates, salts of condensates of naphthalenesulphonic acid, phenolsulphonic acid and formaldehyde and also salts of lignosulphonic acid.

Suitable antifreeze agents are all substances of this type which are usually employed in agrochemical compositions. Preference is given to urea, glycerol, polyglycerol and polyglycerol derivatives, propanediol and propylene glycol.

Suitable antifoams are all substances usually employed for this purpose in agrochemical compositions. Preference is given to silicone oils and magnesium stearate.

Suitable preservatives are all substances of this type usually employed for this purpose in agrochemical compositions. Examples which may be mentioned are Preventol® (from Bayer AG) and Proxel®.

Suitable antioxidants are all substances which are usually employed for this purpose in agrochemical compositions. Examples which may be mentioned are: propyl gallate, octyl gallate, dodecyl gallate, butylated hydroxyanisole, propyl paraben, sodium benzoate, nordihydroguaiaretic acid and butylated hydroxytoluene. Preference is given to butylated hydroxytoluene (2,6-di-t-butyl-4-methylphenol, BHT).

Suitable spreaders are all substances which are usually employed for this purpose in agrochemical compositions. Preference is given to polyether- or organo-modified polysiloxanes.

Suitable colorants are all substances which are usually employed for this purpose in agrochemical compositions. Examples which may be mentioned are titanium dioxide, pigment-grade carbon black, zinc oxide and blue pigments and also permanent red FGR.

Suitable thickeners are all substances of this type which are usually employed in agrochemical compositions. Preference is given to silicates (such as, for example, Atagel® 50 from Engelhard) or xanthan gum (such as, for example, Kelzan® S from Kelko).

The concentrated formulations according to the invention are prepared by mixing the particular ratios desired of the components with one another. The components may be mixed with one another in any order. Expediently, the solid components are employed in a finely ground state. However, it is also possible to subject the suspension formed after mixing of the components initially to a coarse grinding then to a fine grinding so that the mean particle size is below 20 μm. Preferred are suspension concentrates in which the solid particles have a mean particle size of from 1 to 10 μm.

When carrying out the process according to the invention, the temperatures may be varied within a certain range. In general, the process is carried out at temperatures between 10° C. and 60° C., preferably between 15° C. and 40° C.

Suitable for carrying out the process according to the invention are customary mixers and grinders employed for producing agrochemical formulations.

The compositions according to the invention are formulations which are stable even after prolonged storage at elevated temperatures or in the cold, since no crystal growth is observed. By dilution with water, they can be converted into homogeneous spray liquors. The application rate of the compositions according to the invention can be varied within a relatively wide range. It depends on the agrochemically active compounds in question and their content in the compositions.

Compositions according to the invention comprise
at least one active compound selected from the group of insecticidal neonicotinoids, pyrethroids, butenolides, ketoenols, fiproles, anthranilamides, mectins, spinosynes, organophosphates and carbamates and/or at least one active compound selected from the fungicides mentioned above and
at least one adjuvant.

In a preferred embodiment, compositions according to the invention comprise:
at least one active compound of the general formula (II) and/or at least one active compound selected from the group consisting of (III-1) to (III-24) and/or at least one active compound of the general formula (IV) and/or at least one active compound of the general formula (V) and/or at least one active compound selected from the group consisting of (VI-1) and (VI-2) and/or at least one active compound selected from the group consisting of (VII-1) to (VII-23) and/or at least one active compound selected from the group consisting of (VIII-1) to (VIII-6) and/or (IX-1) and/or at least one active compound selected from the class of the organophosphates and/or at least one active compound selected from the class of the carbamates,
and at least one adjuvant.

In a further preferred embodiment, compositions according to the invention comprise:
at least one fungicide selected from the group consisting of etridiazole, fosetyl-aluminum, propamocarb hydrochloride, metalaxyl, metalaxyl-m, benalaxyl-m, azoxystrobin, dimetomorph, pyrimethanil, carbendazim, dithiofencarb, thiophanate-methyl, prochloraz, boscalid, trifloxystrobin, fluoxastrobin, iprodione, propamocarb fosetylate, prothioconazole, triticonazole, fluquinconazole, triadimenol, iprovalicarb, fluopicolide, N-{2-[1,1′-bi(cyclopropyl)-2-yl]phenyl}-3-(difluoromethyl)-1-methyl-1H-pyrazole-4-carboxamide, N-[2-(1,3-dimethylbutyl)phenyl]-5-fluoro-1,3-dimethyl-1H-pyrazole-4-carboxamide, N-(3′,4′-dichloro-5-fluoro-1,1′-biphenyl-2-yl)-3-(difluoromethyl)-1-methyl-1H-pyrazole-4-carboxamide, N-{2-[3-chloro-5-(trifluoromethyl)-2-pyridinyl]ethyl}-2-trifluoromethylbenzamide, 5-chloro-6-(2,4,6-trifluorophenyl)-N-[(1R)-1,2,2-trimethylpropyl][1,2,4]triazolo[1,5-a]pyrimidine-7-amine, 5-chloro-N-[(1R)-1,2-dimethylpropyl]-6-(2,4,6-trifluorophenyl)[1,2,4]triazolo[1,5-a]pyrimidine-7-amine and 5-chloro-7-(4-methylpiperidin-1-yl)-6-(2,4,6-trifluorophenyl)[1,2,4]triazolo[1,5-a]pyrimidine,
at least one adjuvant.

In a particularly preferred embodiment, compositions according to the invention comprise:
at least one active compound of the general formula (II) and/or at least one active compound selected from the group consisting of (III-1) to (III-24) and/or at least one active compound of the general formula (IV) and/or at least one active compound of the general formula (V) and/or at least one active compound selected from the group consisting of (VI-1) and (VI-2) and/or at least one active compound selected from the group consisting of (VII-1) to (VII-23) and/or at least one active compound selected from the group consisting of (VIII-1) to (VIII-6) and/or (IX-1) and/or at least one active compound selected from the group consisting of (X-1) to (X-6) and/or at least one active compound selected from the group consisting of (XI-1) to (XI-3),
and at least one substance or composition selected from the group consisting of (I-1) to (I-12).

In a further particularly preferred embodiment, compositions according to the invention comprise:
at least one fungicide selected from the group consisting of etridiazole, fosetyl-aluminum, propamocarb hydrochloride, metalaxyl, metalaxyl-m, benalaxyl-m, azoxystrobin, dimetomorph, pyrimethanil, carbendazim, dithiofencarb, thiophanate-methyl, prochloraz, boscalid, trifloxystrobin, fluoxastrobin, iprodione, propamocarb fosetylate, prothioconazole, triticonazole, fluquinconazole, triadimenol, iprovalicarb, fluopicolide, N-{2-[1,1′-bi(cyclopropyl)-2-yl]phenyl}-3-(difluoromethyl)-1-methyl-1H-pyrazole-4-carboxamide, N-[2-(1,3-dimethylbutyl)phenyl]-5-fluoro-1,3-dimethyl-1H-pyrazole-4-carboxamide, N-(3′,4′-dichloro-5-fluoro-1,1′-biphenyl-2-yl)-3-(difluoromethyl)-1-methyl-1H-pyrazole-4-carboxamide, N-{2-[3-chloro-5-(trifluoromethyl)-2-pyridinyl]ethyl}-2-trifluoromethylbenzamide, 5-chloro-6-(2,4,6-trifluorophenyl)-N-[(1R)-1,2,2-trimethylpropyl][1,2,4]triazolo[1,5-a]pyrimidine-7-amine, 5-chloro-N-[(1R)-1,2-dimethylpropyl]-6-(2,4,6-trifluorophenyl)[1,2,4]triazolo[1,5-a]pyrimidine-7-amine and 5-chloro-7-(4-methylpiperidin-1-yl)-6-(2,4,6-trifluorophenyl)[1,2,4]triazolo[1,5-a]pyrimidine,
at least one substance or composition selected from the group consisting of (I-1) to (I-12).

In a very particularly preferred embodiment, compositions according to the invention comprise:
at least one active compound selected from the group consisting of (II-7), (IV-1), (V-3) and (VI-1),
at least one substance or composition selected from the group consisting of (I-1) to (I-12).

The compositions according to the invention comprise—if they are concentrated formulations
generally from 1 to 60% by weight of one or more agrochemically active compounds which may be used according to the invention, preferably from 5 to 50% by weight and particularly preferably from 10 to 30% by weight,
generally from 1 to 50% by weight of at least one adjuvant according to the invention, preferably from 2 to 30% by weight and particularly preferably from 5 to 20% by weight,
generally from 1 to 20% by weight of nonionic surfactants and/or anionic surfactants, preferably from 2.5 to 10% by weight,
generally from 1 to 20% by weight of antifreeze agent, preferably from 5 to 15% by weight,
generally from 0.1 to 20% by weight of additives, preferably from 0.1 to 15% by weight.

The compositions according to the invention comprise—if they are ready-to-use formulations (solutions for watering)—generally from 0.05 to 10 g/l of adjuvant, preferably from 0.1 to 8 g/l and particularly preferably from 0.1 to 5 g/l.

Very particularly preferred concentrated formulations for soil application comprise
from 1 to 60% by weight of at least one active compound of the general formula (II) and/or at least one active compound selected from the group consisting of (III-1) to (III-24) and/or at least one active compound of the general formula (IV) and/or at least one active compound of the general formula (V) and/or at least one active compound selected from the group consisting of (VI-1) and (VI-2), and/or at least one active compound selected from the group consisting of (VII-1) to (VII-23) and/or at least one active compound selected from the group consisting of (VIII-1) to (VIII-6) and/or (IX-1) and/or at least one active compound selected from the group consisting of (X-1) to (X-6) and/or at least one active compound selected from the group consisting of (XI-1) to (XI-3),
between 1 and 50% by weight of at least one substance or composition selected from the group consisting of (I-1) to (I-12),
from 1 to 20% by weight of at least one nonionic surfactant and/or anionic surfactant,
from 1 to 20% by weight of antifreeze agent and
from 0.1 to 20% by weight of additives from the groups of the antifoams, the preservatives, the antioxidants, the spreading agents, the colorants and/or the thickeners.

Especially preferred concentrated formulations for soil applications comprise
from 1 to 60% by weight of at least one active compound selected from the group consisting of (II-7), (IV-1), (V-3) and (VI-1),
from 1 to 50% by weight of at least one substance or composition selected from the group consisting of (I-1) to (I-12),
from 1 to 20% by weight of at least one nonionic surfactant and/or anionic surfactant,
from 1 to 20% by weight of antifreeze agent,
from 0.1 to 20% by weight of additives from the groups of the antifoams, the preservatives, the antioxidants, the spreading agents, the colorants and/or the thickeners.

In general, preference is given to certain combinations of active compounds and adjuvants listed in the table below, where each combination is preferred per se:

| | Active | |
|---|---|---|
| # | compound | Adjuvant |
| 1 | (II-7) | Dioctyl sodium sulphosuccinate |
| 2 | (II-7) | Compositions comprising dioctyl sodium sulphosuccinate and sodium |
| | | benzoate |
| 3 | (II-7) | Terminally capped alkoxylated fatty alcohols and terminally capped |
| | | alkoxylated straight-chain alcohols |
| 4 | (II-7) | Tributylphenol polyglycol ethers having 10 to 15 EO units |
| 5 | (II-7) | Polyalkylene oxide-modified polymethylsiloxane |
| 6 | (II-7) | Branched alkanol alkoxylates of the formula |
| | | CH₃—(CH₂)ₜ—CH₂—O—(—CH₂—CH₂—O—)ᵤ—H, in which t represents |
| | | numbers from 9 to 10.5 and u represents numbers from 6 to 25 |
| 7 | (II-7) | Betaine |
| 8 | (II-7) | Polyalkoxylated triglycerides |
| 9 | (II-7) | Alkoxylated fatty amines |
| 10 | (II-7) | Sodium laureth sulphate |
| 11 | (II-7) | PEG-10 coconut alcohol |
| 12 | (II-7) | Compositions comprising maize syrup, petroleum oil and nonionic |
| | | emulsifier |
| 13 | (IV-1) | Dioctyl sodium sulphosuccinate |
| 14 | (IV-1) | Compositions comprising dioctyl sodium sulphosuccinate and sodium |
| | | benzoate |
| 15 | (IV-1) | Terminally capped alkoxylated fatty alcohols and terminally capped |
| | | alkoxylated straight-chain alcohols |
| 16 | (IV-1) | Tributylphenol polyglycol ethers having 10 to 15 EO units |
| 17 | (IV-1) | Polyalkylene oxide-modified polymethylsiloxane |
| 18 | (IV-1) | Branched alkanol alkoxylates of the formula |
| | | CH₃—(CH₂)ₜ—CH₂—O—(—CH₂—CH₂—O—)ᵤ—H, in which t represents |
| | | numbers from 9 to 10.5 and u represents numbers from 6 to 25 |
| 19 | (IV-1) | Betaine |
| 20 | (IV-1) | Polyalkoxylated triglycerides |
| 21 | (IV-1) | Alkoxylated fatty amines |
| 22 | (IV-1) | Sodium laureth sulphate |
| 23 | (IV-1) | PEG-10 coconut alcohol |
| 24 | (IV-1) | Compositions comprising maize syrup, petroleum oil and nonionic |
| | | emulsifier |
| 25 | (V-3) | Dioctyl sodium sulphosuccinate |
| 26 | (V-3) | Compositions comprising dioctyl sodium sulphosuccinate and sodium |
| | | benzoate |
| 27 | (V-3) | Terminally capped alkoxylated fatty alcohols and terminally capped |
| | | alkoxylated straight-chain alcohols |
| 28 | (V-3) | Tributylphenol polyglycol ethers having 10 to 15 EO units |
| 29 | (V-3) | Polyalkylene oxide-modified polymethylsiloxane |
| 30 | (V-3) | Branched alkanol alkoxylates of the formula |
| | | CH₃—(CH₂)ₜ—CH₂—O—(—CH₂—CH₂—O—)ᵤ—H, in which t represents |
| | | numbers from 9 to 10.5 and u represents numbers from 6 to 25 |
| 31 | (V-3) | Betaine |
| 32 | (V-3) | Polyalkoxylated triglycerides |
| 33 | (V-3) | Alkoxylated fatty amines |
| 34 | (V-3) | Sodium laureth sulphate |
| 35 | (V-3) | PEG-10 coconut alcohol |
| 36 | (V-3) | Compositions comprising maize syrup, petroleum oil and nonionic |
| | | emulsifier |
| 37 | (VI-1) | Dioctyl sodium sulphosuccinate |
| 38 | (VI-1) | Compositions comprising dioctyl sodium sulphosuccinate and sodium |
| | | benzoate |
| 39 | (VI-1) | Terminally capped alkoxylated fatty alcohols and terminally capped |
| | | alkoxylated straight-chain alcohols |
| 40 | (VI-1) | Tributylphenol polyglycol ethers having 10 to 15 EO units |
| 41 | (VI-1) | Polyalkylene oxide-modified polymethylsiloxane |
| 42 | (VI-1) | Branched alkanol alkoxylates of the formula |
| | | CH₃—(CH₂)ₜ—CH₂—O—(—CH₂—CH₂—O—)ᵤ—H, in which t represents |
| | | numbers from 9 to 10.5 and u represents numbers from 6 to 25 |
| 43 | (VI-1) | Betaine |
| 44 | (VI-1) | Polyalkoxylated triglycerides |
| 45 | (VI-1) | Alkoxylated fatty amines |
| 46 | (VI-1) | Sodium laureth sulphate |
| 47 | (VI-1) | PEG-10 coconut alcohol |
| 48 | (VI-1) | Compositions comprising maize syrup, petroleum oil and nonionic |
| | | emulsifier |

Very particular preference is also given to ready-to-use compositions for soil applications which are obtained by diluting the concentrated solutions mentioned above.

The insecticidal compositions of the invention, in combination with good plant tolerance, favourable toxicity to warm-blooded animals and high compatibility with the environment, are suitable for protecting plants and plant organs, for increasing the harvest yields, for improving the quality of the harvested material and for controlling animal pests, more particularly insects, arachnids, helminths, nematodes and molluscs, which are encountered in agriculture, in horticulture, in forests, in gardens and leisure facilities. They may be preferably employed as crop protection agents. They are active against normally sensitive and resistant species and against all or some stages of development. The abovementioned pests include:

From the order of the Anoplura (Phthiraptera), for example, Damalinia spp., Haematopinus spp., Linognathus spp., Pediculus spp., Trichodectes spp.

From the class of the Arachnida, for example, Acarus siro, Aceria sheldoni, Aculops spp., Aculus spp., Amblyomma spp., Argas spp., Boophilus spp., Brevipalpus spp., Bryobia praetiosa, Chorioptes spp., Dermanyssus gallinae, Eotetranychus spp., Epitrimerus pyri, Eutetranychus spp., Eriophyes spp., Hemitarsonemus spp., Hyalomma spp., Ixodes spp., Latrodectus mactans, Metatetranychus spp., Oligonychus spp., Ornithodoros spp., Panonychus spp., Phyllocoptruta oleivora, Polyphagotarsonemus latus, Psoroptes spp., Rhipicephalus spp., Rhizoglyphus spp., Sarcoptes spp., Scorpio maurus, Stenotarsonemus spp., Tarsonemus spp., Tetranychus spp., Vasates lycopersici.

From the class of the Bivalva, for example, Dreissena spp.

From the order of the Chilopoda, for example, Geophilus spp., Scutigera spp.

From the order of the Coleoptera, for example, Acanthoscelides obtectus, Adoretus spp., Agelastica alni, Agriotes spp., Amphimallon solstitialis, Anobium punctatum, Anoplophora spp., Anthonomus spp., Anthrenus spp., Apogonia spp., Atomaria spp., Attagenus spp., Bruchidius obtectus, Bruchus spp., Ceuthorhynchus spp., Cleonus mendicus, Conoderus spp., Cosmopolites spp., Costelytra zealandica, Curculio spp., Cryptorhynchus lapathi, Dermestes spp., Diabrotica spp., Epilachna spp., Faustinus cubae, Gibbium psylloides, Heteronychus arator, Hylamorpha elegans, Hylotrupes bajulus, Hypera postica, Hypothenemus spp., Lachnosterna consanguinea, Leptinotarsa decemlineata, Lissorhoptrus oryzophilus, Lixus spp., Lyctus spp., Meligethes aeneus, Melolontha melolontha, Migdolus spp., Monochamus spp., Naupactus xanthographus, Niptus hololeucus, Oryctes rhinoceros, Oryzaephilus surinamensis, Otiorrhynchus sulcatus, Oxycetonia jucunda, Phaedon cochleariae, Phyllophaga spp., Popillia japonica, Premnotrypes spp., Psylliodes chrysocephala, Ptinus spp., Rhizobius ventralis, Rhizopertha dominica, Sitophilus spp., Sphenophorus spp., Sternechus spp., Symphyletes spp., Tenebrio molitor, Tribolium spp., Trogoderma spp., Tychius spp., Xylotrechus spp., Zabrus spp.

From the order of the Collembola, for example, Onychiurus armatus.

From the order of the Dermaptera, for example, Forficula auricularia.

From the order of the Diplopoda, for example, Blaniulus guttulatus.

From the order of the Diptera, for example, Aedes spp., Anopheles spp., Bibio hortulanus, Calliphora erythrocephala, Ceratitis capitata, Chrysomyia spp., Cochliomyia spp., Cordylobia anthropophaga, Culex spp., Cuterebra spp., Dacus oleae, Dermatobia hominis, Drosophila spp., Fannia spp., Gastrophilus spp., Hylemyia spp., Hyppobosca spp., Hypoderma spp., Liriomyza spp., Lucilia spp., Musca spp., Nezara spp., Oestrus spp., Oscinella frit, Pegomyia hyoscyami, Phorbia spp., Stomoxys spp., Tabanus spp., Tannia spp., Tipula paludosa, Wohlfahrtia spp.

From the class of the Gastropoda, for example, Arion spp., Biomphalaria spp., Bulinus spp., Deroceras spp., Galba spp., Lymnaea spp., Oncomelania spp., Succinea spp.

From the class of the helminths, for example, Ancylostoma duodenale, Ancylostoma ceylanicum, Acylostoma braziliensis, Ancylostoma spp., Ascaris lubricoides, Ascaris spp., Brugia malayi, Brugia timori, Bunostomum spp., Chabertia spp., Clonorchis spp., Cooperia spp., Dicrocoelium spp, Dictyocaulus filaria, Diphyllobothrium latum, Dracunculus medinensis, Echinococcus granulosus, Echinococcus multilocularis, Enterobius vermicularis, Faciola spp., Haemonchus spp., Heterakis spp., Hymenolepis nana, Hyostrongulus spp., Loa Loa, Nematodirus spp., Oesophagostomum spp., Opisthorchis spp., Onchocerca volvulus, Ostertagia spp., Paragonimus spp., Schistosomen spp., Strongyloides fuelleborni, Strongyloides stercoralis, Stronyloides spp., Taenia saginata, Taenia solium, Trichinella spiralis, Trichinella nativa, Trichinella britovi, Trichinella nelsoni, Trichinella pseudopsiralis, Trichostrongulus spp., Trichuris trichuria, Wuchereria bancrofti.

It is further possible to control protozoa, such as Eimeria.

From the order of the Heteroptera, for example, Anasa tristis, Antestiopsis spp., Blissus spp., Calocoris spp., Campylomma livida, Cavelerius spp., Cimex spp., Creontiades dilutus, Dasynus piperis, Dichelops furcatus, Diconocoris hewetti, Dysdercus spp., Euschistus spp., Eurygaster spp., Heliopeltis spp., Horcias nobilellus, Leptocorisa spp., Leptoglossus phyllopus, Lygus spp., Macropes excavatus, Miridae, Nezara spp., Oebalus spp., Pentomidae, Piesma quadrata, Piezodorus spp., Psallus seriatus, Pseudacysta persea, Rhodnius spp., Sahlbergella singularis, Scotinophora spp., Stephanitis nashi, Tibraca spp., Triatoma spp.

From the order of the Homoptera, for example, Acyrthosipon spp., Aeneolamia spp., Agonoscena spp., Aleurodes spp., Aleurolobus barodensis, Aleurothrixus spp., Amrasca spp., Anuraphis cardui, Aonidiella spp., Aphanostigma piri, Aphis spp., Arboridia apicalis, Aspidiella spp., Aspidiotus spp., Atanus spp., Aulacorthum solani, Bemisia spp., Brachycaudus helichrysii, Brachycolus spp., Brevicoryne brassicae, Calligypona marginata, Carneocephala fulgida, Ceratovacuna lanigera, Cercopidae, Ceroplastes spp., Chaetosiphon fragaefolii, Chionaspis tegalensis, Chlorita onukii, Chromaphis juglandicola, Chrysomphalus ficus, Cicadulina mbila, Coccomytilus halli, Coccus spp., Cryptomyzus ribis, Dalbulus spp., Dialeurodes spp., Diaphorina spp., Diaspis spp., Doralis spp., Drosicha spp., Dysaphis spp., Dysmicoccus spp., Empoasca spp., Eriosoma spp., Erythroneura spp., Euscelis bilobatus, Geococcus coffeae, Homalodisca coagulata, Hyalopterus arundinis, Icerya spp., Idiocerus spp., Idioscopus spp., Laodelphax striatellus, Lecanium spp., Lepidosaphes spp., Lipaphis erysimi, Macrosiphum spp., Mahanarva fimbriolata, Melanaphis sacchari, Metcalfiella spp., Metopolophium dirhodum, Monellia costalis, Monelliopsis pecanis, Myzus spp., Nasonovia ribisnigri, Nephotettix spp., Nilaparvata lugens, Oncometopia spp., Orthezia praelonga, Parabemisia myricae, Paratrioza spp., Parlatoria spp., Pemphigus spp., Peregrinus maidis, Phenacoccus spp., Phloeomyzus passerinii, Phorodon humuli, Phylloxera spp., Pinnaspis aspidistrae, Planococcus spp., Protopulvinaria pyriformis, Pseudaulacaspis pentagona, Pseudococcus spp., Psylla spp., Pteromalus spp., Pyrilla spp., Quadraspidiotus spp., Quesada gigas, Rastrococcus spp., Rhopalosiphum spp., Saissetia spp., Scaphoides titanus, Schizaphis graminum, Selenaspidus articulatus, Sogata spp., Sogatella furcifera, Sogatodes spp., Stictocephala festina, Tenalaphara malayensis, Tinocallis caryaefoliae, Tomaspis spp., Toxoptera spp., Trialeurodes vaporariorum, Trioza spp., Typhlocyba spp., Unaspis spp., Viteus vitifolii.

From the order of the Hymenoptera, for example, Diprion spp., Hoplocampa spp., Lasius spp., Monomorium pharaonis, Vespa spp.

From the order of the Isopoda, for example, Armadillidium vulgare, Oniscus asellus, Porcellio scaber.

From the order of the Isoptera, for example, Reticulitermes spp., Odontotermes spp.

From the order of the Lepidoptera, for example, Acronicta major, Aedia leucomelas, Agrotis spp., Alabama argillacea, Anticarsia spp., Barathra brassicae, Bucculatrix thurberiella, Bupalus piniarius, Cacoecia podana, Capua reticulana, Carpocapsa pomonella, Cheimatobia brumata, Chilo spp., Choristoneura fumiferana, Clysia ambiguella, Cnaphalocerus spp., Earias insulana, Ephestia kuehniella, Euproctis chrysorrhoea, Euxoa spp., Feltia spp., Galleria mellonella, Helicoverpa spp., Heliothis spp., Hofmannophila pseudospretella, Homona magnanima, Hyponomeuta padella, Laphygma spp., Lithocolletis blancardella, Lithophane antennata, Loxagrotis albicosta, Lymantria spp., Malacosoma neustria, Mamestra brassicae, Mocis repanda, Mythimna separata, Oria spp., Oulema oryzae, Panolis flammea, Pectinophora gossypiella, Phyllocnistis citrella, Pieris spp., Plutella xylostella, Prodenia spp., Pseudaletia spp., Pseudoplusia includens, Pyrausta nubilalis, Spodoptera spp., Thermesia gemmatalis, Tinea pellionella, Tineola bisselliella, Tortrix viridana, Trichoplusia spp.

From the order of the Orthoptera, for example, Acheta domesticus, Blatta orientalis, Blattella germanica, Gryllotalpa spp., Leucophaea maderae, Locusta spp., Melanoplus spp., Periplaneta americana, Schistocerca gregaria.

From the order of the Siphonaptera, for example, Ceratophyllus spp., Xenopsylla cheopis.

From the order of the Symphyla, for example, Scutigerella immaculata.

From the order of the Thysanoptera, for example, Baliothrips biformis, Enneothrips flavens, Frankliniella spp., Heliothrips spp., Hercinothrips femoralis, Kakothrips spp., Rhipiphorothrips cruentatus, Scirtothrips spp., Taeniothrips cardamoni, Thrips spp.

From the order of the Thysanura, for example, Lepisma saccharina.

The phytoparasitic nematodes include, for example, Anguina spp., Aphelenchoides spp., Belonoaimus spp., Bursaphelenchus spp., Ditylenchus dipsaci, Globodera spp., Heliocotylenchus spp., Heterodera spp., Longidorus spp., Meloidogyne spp., Pratylenchus spp., Radopholus similis, Rotylenchus spp., Trichodorus spp., Tylenchorhynchus spp., Tylenchulus spp., Tylenchulus semipenetrans, Xiphinema spp.

Insecticidal compositions of the invention can in addition to at least one of the abovementioned active compounds comprise other active compounds as well, such as further insecticides, attractants, sterilants, bactericides, acaricides, nematicides, fungicides, growth-regulating substances, herbicides, safeners, fertilizers or semiochemicals.

Particularly favourable co-components are, for example, the following components:

Bactericides:

bronopol, dichlorophen, nitrapyrin, nickel dimethyldithiocarbamate, kasugamycin, octhilinone, furancarboxylic acid, oxytetracycline, probenazole, streptomycin, tecloftalam, copper sulphate and other copper preparations.

Insecticides/acaricides/nematicides:

Sodium channel modulators/voltage-dependent sodium channel blockers
DDT
oxadiazines,
for example indoxacarb
semicarbazone,
for example metaflumizone (BAS3201)

Acetylcholine receptor agonists/antagonists
nicotine, bensultap, cartap

GABA-gated chloride channel antagonists
organochlorines,
for example camphechlor, chlordane, endosulfan, gamma-HCH, HCH, heptachlor, lindane, methoxychlor
fiprol,
for example acetoprole, pyrafluprole, pyriprole, vaniliprole

Juvenile hormone mimetics,
for example diofenolan, epofenonane, fenoxycarb, hydroprene, kinoprene, methoprene, pyriproxifen, triprene

Ecdysone agonists/disruptors
diacylhydrazines,
for example chromafenozide, halofenozide, methoxyfenozide, tebufenozide

Chitin biosynthesis inhibitors
benzoylureas,
for example bistrifluron, chlofluazuron, diflubenzuron, fluazuron, flucycloxuron, flufenoxuron, hexaflumuron, lufenuron, novaluron, noviflumuron, penfluron, teflubenzuron, triflumuron
buprofezin
cyromazine

Oxidative phosphorylation inhibitors, ATP disruptors
diafenthiuron
organotin compounds,
for example azocyclotin, cyhexatin, fenbutatin oxide

Oxidative phosphorylation decouplers acting by interrupting the H-proton gradient
pyrroles,
for example chlorfenapyr
dinitrophenols,
for example binapacyrl, dinobuton, dinocap, DNOC

Site-I electron transport inhibitors
METIs,
for example fenazaquin, fenpyroximate, pyrimidifen, pyridaben, tebufenpyrad,

tolfenpyrad
hydramethylnon
dicofol

Site-II electron transport inhibitors
rotenone

Site-III electron transport inhibitors
acequinocyl, fluacrypyrim

Microbial disruptors of the insect gut membrane
Bacillus thuringiensis strains

Lipid synthesis inhibitors
tetramic acids,
for example cis-3-(2,5-dimethylphenyl)-4-hydroxy-8-methoxy-1-aza-spiro[4.5]dec-3-en-2-one
carboxamides,
for example flonicamid
octopaminergic agonists,
for example amitraz

Inhibitors of magnesium-stimulated ATPase,
propargite
nereistoxin analogues,
for example thiocyclam hydrogen oxalate, thiosultap-sodium

Biologicals, hormones or pheromones
azadirachtin, Bacillus spec., Beauveria spec., codlemone, Metarrhizium spec., Paecilomyces spec., thuringiensin, Verticillium spec.

Active compounds with unknown or non-specific mechanisms of action
fumigants,
for example aluminum phosphide, methyl bromide, sulphuryl fluoride
antifeedants,
for example cryolite, flonicamid, pymetrozine
mite growth inhibitors,
for example clofentezine, etoxazole, hexythiazox
amidoflumet, benclothiaz, benzoximate, bifenazate, bromopropylate, buprofezin, chinomethionat, chlordimeform, chlorobenzilate, chloropicrin, clothiazoben, cycloprene, cyflumetofen, dicyclanil, fenoxacrim, fentrifanil, flubenzimine, flufenerim, flutenzin, gossyplure, hydramethylnone, japonilure, metoxadiazone, petroleum, piperonyl butoxide, potassium oleate, pyridalyl, sulfluramid, tetradifon, tetrasul, triarathene, verbutin

The compositions of the invention can further comprise synergists. Synergists are compounds which boost the action of the active compounds, without it being necessary for the synergist added to be active itself.

The compositions of the invention can further comprise inhibitors which reduce degradation of the active compound after application.

The formulation is employed in a customary manner adapted to it. Treatment according to the invention of the plants and plant parts with the compositions is carried by soil treatment, for example, as described above.

As already mentioned above, it is possible to treat all plants according to the invention. In a preferred embodiment, wild plant species and plant cultivars, or those obtained by conventional biological breeding methods, such as crossing or protoplast fusion, and parts thereof, are treated. In a further preferred embodiment, transgenic plants and plant cultivars obtained by genetic engineering methods, if appropriate in combination with conventional methods (Genetically Modified Organisms), are treated.

With particular preference, plants of the plant cultivars which are in each case commercially available or in use are treated according to the invention. Plant cultivars are to be understood as meaning plants having novel properties (“traits”) which have been obtained by conventional breeding, by mutagenesis or by recombinant DNA techniques. They can be cultivars, bio- and genotypes.

Depending on the plant species or plant cultivars, their location and growth conditions (soils, climate, vegetation period, diet), the treatment according to the invention may also result in superadditive (“synergistic”) effects. Thus, for example, reduced application rates and/or expansions of the activity spectrum and/or a boost to the activity of the compositions of the invention, better plant growth, increased tolerance to high or low temperatures, increased tolerance to drought or to water or soil salt content, increased flowering performance, easier harvesting, accelerated maturation, higher harvest yields, higher quality and/or higher nutritional value of the harvested products, better keeping properties and/or processability of the harvested products are possible, which exceed the effects which were actually to be expected.

The transgenic plants or plant cultivars (obtained by genetic engineering) which are preferably to be treated according to the invention include all plants which, by virtue of the genetic modification, received genetic material which imparts particularly advantageous, useful traits to these plants. Examples of such traits are better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better keeping properties and/or processability of the harvested products. Further and particularly emphasized examples of such traits are a better defence of the plants against animal and microbial pests, such as against insects, mites, phytopathogenic fungi, bacteria and/or viruses, and also increased tolerance of the plants to certain herbicidally active compounds. Examples of transgenic plants which may be mentioned are the important crop plants, such as cereals (wheat, rice), maize, soya beans, potatoes, sugar beet, tomatoes, peas and other vegetable varieties, cotton, tobacco, oilseed rape and also fruit plants (with the fruits apples, pears, citrus fruits and grapes), and particular emphasis is given to maize, soya beans, potatoes, cotton, tobacco and oilseed rape. Traits that are emphasized in particular are increased defence of the plants against insects, arachnids, nematodes and slugs and snails by virtue of toxins formed in the plants, in particular those formed in the plants by the genetic material from Bacillus thuringiensis (for example by the genes CryIA(a), CryIA(b), CryIA(c), CryIIA, CryIIIA, CryIIIB2, Cry9c, Cry2Ab, Cry3Bb and CryIF and also combinations thereof) (referred to hereinbelow as “Bt plants”). Traits that are also particularly emphasized are the increased defence of the plants against fungi, bacteria and viruses by systemic acquired resistance (SAR), systemin, phytoalexins, elicitors and resistance genes and correspondingly expressed proteins and toxins. Traits that are further particularly emphasized are the increased tolerance of the plants to certain herbicidally active compounds, for example imidazolinones, sulphonylureas, glyphosate or phosphinotricin (for example the “PAT” gene). The genes which impart the desired traits in question can also be present in combination with one another in the transgenic plants. Examples of “Bt plants” which may be mentioned are maize varieties, cotton varieties, soya bean varieties and potato varieties which are sold under the trade names YIELD GARD® (for example maize, cotton, soya beans), KnockOut® (for example maize), StarLink® (for example maize), Bollgard® (cotton), Nucotn® (cotton) and NewLeaf® (potato). Examples of herbicide-tolerant plants which may be mentioned are maize varieties, cotton varieties and soya bean varieties which are sold under the trade names Roundup Ready® (tolerance to glyphosate, for example maize, cotton, soya beans), Liberty Link® (tolerance to phosphinotricin, for example oilseed rape), IMI® (tolerance to imidazolinones) and STS® (tolerance to sulphonylureas, for example maize). Herbicide-resistant plants (plants bred in a conventional manner for herbicide tolerance) which may be mentioned include the varieties sold under the name Clearfield® (for example maize). Of course, these statements also apply to plant cultivars which have these genetic traits, or genetic traits still to be developed, and which will be developed and/or marketed in the future.

The plants listed can be treated according to the invention in a particularly advantageous manner with the compositions of the invention. The preferred ranges stated above also apply to the treatment of these plants. Particular emphasis is given to the treatment of plants with the compositions specifically mentioned in the present text.

In domestic, hygiene and stored-product protection, the compositions are also suitable for controlling animal pests, particularly insects, arachnids and mites, which are found in enclosed spaces such as, for example, dwellings, factory halls, offices, vehicle cabins and the like. They can be employed alone or in combination with other active compounds and auxiliaries in domestic insecticide products for controlling these pests. They are active against sensitive and resistant species and against all developmental stages. These pests include:

From the order of the Scorpionidea, for example, Buthus occitanus.

From the order of the Acarina, for example, Argas persicus, Argas reflexus, Bryobia ssp., Dermanyssus gallinae, Glyciphagus domesticus, Ornithodorus moubat, Rhipicephalus sanguineus, Trombicula alfreddugesi, Neutrombicula autumnalis, Dermatophagoides pteronissimus, Dermatophagoides forinae.

From the order of the Araneae, for example, Aviculariidae, Araneidae.

From the order of the Opiliones, for example, Pseudoscorpiones chelifer, Pseudoscorpiones cheiridium, Opiliones phalangium.

From the order of the Isopoda, for example, Oniscus asellus, Porcellio scaber.

From the order of the Diplopoda, for example, Blaniulus guttulatus, Polydesmus spp.

From the order of the Chilopoda, for example, Geophilus spp.

From the order of the Zygentoma, for example, Ctenolepisma spp., Lepisma saccharina, Lepismodes inquilinus.

From the order of the Blattaria, for example, Blatta orientalies, Blattella germanica, Blattella asahinai, Leucophaea maderae, Panchlora spp., Parcoblatta spp., Periplaneta australasiae, Periplaneta americana, Periplaneta brunnea, Periplaneta fuliginosa, Supella longipalpa.

From the order of the Saltatoria, for example, Acheta domesticus.

From the order of the Dermaptera, for example, Forficula auricularia.

From the order of the Isoptera, for example, Kalotermes spp., Reticulitermes spp.

From the order of the Psocoptera, for example, Lepinatus spp., Liposcelis spp.

From the order of the Coleoptera, for example, Anthrenus spp., Attagenus spp., Dermestes spp., Latheticus oryzae, Necrobia spp., Ptinus spp., Rhizopertha dominica, Sitophilus granarius, Sitophilus oryzae, Sitophilus zeamais, Stegobium paniceum.

From the order of the Diptera, for example, Aedes aegypti, Aedes albopictus, Aedes taeniorhynchus, Anopheles spp., Calliphora erythrocephala, Chrysozona pluvialis, Culex quinquefasciatus, Culex pipiens, Culex tarsalis, Drosophila spp., Fannia canicularis, Musca domestica, Phlebotomus spp., Sarcophaga carnaria, Simulium spp., Stomoxys calcitrans, Tipula paludosa.

From the order of the Lepidoptera, for example, Achroia grisella, Galleria mellonella, Plodia interpunctella, Tinea cloacella, Tinea pellionella, Tineola bisselliella.

From the order of the Siphonaptera, for example, Ctenocephalides canis, Ctenocephalides felis, Pulex irritans, Tunga penetrans, Xenopsylla cheopis.

From the order of the Hymenoptera, for example, Camponotus herculeanus, Lasius fuliginosus, Lasius niger, Lasius umbratus, Monomorium pharaonis, Paravespula spp., Tetramorium caespitum.

From the order of the Anoplura, for example, Pediculus humanus capitis, Pediculus humanus corporis, Pemphigus spp., Phylloera vastatrix, Phthirus pubis.

From the order of the Heteroptera, for example, Cimex hemipterus, Cimex lectularius, Rhodinus prolixus, Triatoma infestans.

In the field of domestic insecticides, they are used alone or in combination with other suitable active compounds, such as phosphoric esters, carbamates, pyrethroides, neonicotinoids, growth regulators or active compounds from other known classes of insecticides.

The fungicidal compositions according to the invention have very good fungicidal properties and can be used for controlling phytopathogenic fungi, such as Plasmodiophoromycetes, Oomycetes, Chytridiomycetes, Zygomycetes, Ascomycetes, Basidiomycetes, Deuteromycetes, etc.

Some pathogens causing fungal diseases which come under the generic names listed above may be mentioned as examples, but not by way of limitation:

Diseases caused by powdery mildew pathogens, such as, for example,

Blumeria species, such as, for example, Blumeria graminis;

Podosphaera species, such as, for example, Podosphaera leucotricha;

Sphaerotheca species, such as, for example, Sphaerotheca fuliginea;

Uncinula species, such as, for example, Uncinula necator;

Diseases caused by rust disease pathogens, such as, for example,

Gymnosporangium species, such as, for example, Gymnosporangium sabinae

Hemileia species, such as, for example, Hemileia vastatrix;

Phakopsora species, such as, for example, Phakopsora pachyrhizi and Phakopsora meibomiae;

Puccinia species, such as, for example, Puccinia recondita or Puccinia triticina;

Uromyces species, such as, for example, Uromyces appendiculatus;

Diseases caused by pathogens from the group of the Oomycetes, such as, for example,

Bremia species, such as, for example, Bremia lactucae;

Peronospora species, such as, for example, Peronospora pisi or P. brassicae;

Phytophthora species, such as, for example Phytophthora infestans;

Plasmopara species, such as, for example, Plasmopara viticola;

Pseudoperonospora species, such as, for example, Pseudoperonospora humuli or Pseudoperonospora cubensis;

Pythium species, such as, for example, Pythium ultimum;

Leaf blotch diseases and leaf wilt diseases caused, for example, by

Alternaria species, such as, for example, Alternaria solani;

Cercospora species, such as, for example, Cercospora beticola;

Cladiosporium species, such as, for example, Cladiosporium cucumerinum;

Cochliobolus species, such as, for example, Cochliobolus sativus

(conidia form: Drechslera, Syn: Helminthosporium);

Colletotrichum species, such as, for example, Colletotrichum lindemuthanium;

Cycloconium species, such as, for example, Cycloconium oleaginum;

Diaporthe species, such as, for example, Diaporthe citri;

Elsinoe species, such as, for example, Elsinoe fawcettii;

Gloeosporium species, such as, for example, Gloeosporium laeticolor;

Glomerella species, such as, for example, Glomerella cingulata;

Guignardia species, such as, for example, Guignardia bidwelli;

Leptosphaeria species, such as, for example, Leptosphaeria maculans;

Magnaporthe species, such as, for example, Magnaporthe grisea;

Mycosphaerella species, such as, for example, Mycosphaerelle graminicola;

Phaeosphaeria species, such as, for example, Phaeosphaeria nodorum;

Pyrenophora species, such as, for example, Pyrenophora teres;

Ramularia species, such as, for example, Ramularia collo-cygni;

Rhynchosporium species, such as, for example, Rhynchosporium secalis;

Septoria species, such as, for example, Septoria apii;

Typhula species, such as, for example, Typhula incarnata;

Venturia species, such as, for example, Venturia inaequalis;

Root and stem diseases caused, for example, by

Corticium species, such as, for example, Corticium graminearum;

Fusarium species, such as, for example, Fusarium oxysporum;

Gaeumannomyces species, such as, for example, Gaeumannomyces graminis;

Rhizoctonia species, such as, for example Rhizoctonia solani;

Tapesia species, such as, for example, Tapesia acuformis;

Thielaviopsis species, such as, for example, Thielaviopsis basicola;

Ear and panicle diseases (including maize cobs) caused, for example, by

Alternaria species, such as, for example, Alternaria spp.;

Aspergillus species, such as, for example, Aspergillus flavus;

Cladosporium species, such as, for example, Cladosporium spp.;

Claviceps species, such as, for example, Claviceps purpurea;

Fusarium species, such as, for example, Fusarium culmorum;

Gibberella species, such as, for example, Gibberella zeae;

Monographella species, such as, for example, Monographella nivalis;

Diseases caused by smut fungi, such as, for example,

Sphacelotheca species, such as, for example, Sphacelotheca reiliana;

Tilletia species, such as, for example, Tilletia caries;

Urocystis species, such as, for example, Urocystis occulta;

Ustilago species, such as, for example, Ustilago nuda;

Fruit rot caused, for example, by

Aspergillus species, such as, for example, Aspergillus flavus;

Botrytis species, such as, for example, Botrytis cinerea;

Penicillium species, such as, for example, Penicillium expansum;

Sclerotinia species, such as, for example, Sclerotinia sclerotiorum;

Verticilium species, such as, for example, Verticilium alboatrum;

Seed- and soil-borne rot and wilt diseases, and also diseases of seedlings, caused, for example, by

Fusarium species, such as, for example, Fusarium culmorum;

Phytophthora species, such as, for example, Phytophthora cactorum;

Pythium species, such as, for example, Pythium ultimum;

Rhizoctonia species, such as, for example, Rhizoctonia solani;

Sclerotium species, such as, for example, Sclerotium rolfsii;

Cancerous diseases, galls and witches' broom caused, for example, by

Nectria species, such as, for example, Nectria galligena;

Wilt diseases caused, for example, by

Monilinia species, such as, for example, Monilinia laxa;

Deformations of leaves, flowers and fruits caused, for example, by

Taphrina species, such as, for example, Taphrina deformans;

Degenerative diseases of woody plants caused, for example, by

Esca species, such as, for example, Phaemoniella clamydospora;

Diseases of flowers and seeds caused, for example, by

Botrytis species, such as, for example, Botrytis cinerea;

Diseases of plant tubers caused, for example, by

Rhizoctonia species, such as, for example, Rhizoctonia solani;

Diseases caused by bacteriopathogens, such as, for example,

Xanthomonas species, such as, for example, Xanthomonas campestris pv. oryzae;

Pseudomonas species, such as, for example, Pseudomonas syringae pv. lachrymans;

Erwinia species, such as, for example, Erwinia amylovora.

Preference is given to controlling the following diseases of soya beans:

fungal diseases on leaves, stems, pods and seeds caused, for example, by

alternaria leaf spot (Alternaria spec. atrans tenuissima), anthracnose (Colletotrichum gloeosporoides dematium var. truncatum), brown spot (Septoria glycines), cercospora leaf spot and blight (Cercospora kikuchii), choanephora leaf blight (Choanephora infundibulifera trispora (Syn.)), dactuliophora leaf spot (Dactuliophora glycines), downy mildew (Peronospora manshurica), drechslera blight (Drechslera glycini), frogeye leaf spot (Cercospora sojina), leptosphaerulina leaf spot (Leptosphaerulina trifolii), phyllostica leaf spot (Phyllosticta sojaecola), powdery mildew (Microsphaera diffusa), pyrenochaeta leaf spot (Pyrenochaeta glycines), rhizoctonia aerial, foliage, and web blight (Rhizoctonia solani), rust (Phakopsora pachyrhizi), scab (Sphaceloma glycines), stemphylium leaf blight (Stemphylium botryosum), target spot (Corynespora cassiicola)

Fungal diseases on roots and the stem base caused, for example, by

black root rot (Calonectria crotalariae), charcoal rot (Macrophomina phaseolina), fusarium blight or wilt, root rot, and pod and collar rot (Fusarium oxysporum, Fusarium orthoceras, Fusarium semitectum, Fusarium equiseti), mycoleptodiscus root rot (Mycoleptodiscus terrestris), neocosmospora (Neocosmospora vasinfecta), pod and stem blight (Diaporthe phaseolorum), stem canker (Diaporthe phaseolorum var. caulivora), phytophthora rot (Phytophthora megasperma), brown stem rot (Phialophora gregata), pythium rot (Pythium aphanidermatum, Pythium irregulare, Pythium debaryanum, Pythium myriotylum, Pythium ultimum), rhizoctonia root rot, stem decay, and damping-off (Rhizoctonia solani), sclerotinia stem decay (Sclerotinia sclerotiorum), sclerotinia Southern blight (Sclerotinia rolfsii), thielaviopsis root rot (Thielaviopsis basicola).

The examples below illustrate the invention without limiting it in any aspect.

### PREPARATION EXAMPLES

To prepare a suspension concentrate, initially all liquid components are mixed with one another. In the next step, the solids are added and the mixture is stirred until a homogeneous suspension is formed. The homogeneous suspension is subjected initially to coarse grinding and then to fine grinding, resulting in a solution in which 90% of the solids particles have a particle size below 10 μm. Subsequently, Kelzan S and water are added at room temperature with stirring. This gives a homogeneous suspension concentrate. Contents are stated in % by weight.

TABLE 1
Compositions of formulations according to the invention

| | Example | | | | | | | | |
|---|---|---|---|---|---|---|---|---|---|
| | 1 | 2 | 3 | 4 | 5 | 6 | 7 | 8 | 9 |
| Imidacloprid | 21.6 | 21.6 | 21.6 | 21.6 | 21.6 | 21.6 | 21.6 | 21.6 | 21.6 |
| Kelzan ® S | 0.2 | 0.1 | 0.1 | 0.5 | 0.1 | 0.3 | 0.1 | 0.1 | 0.1 |
| Preventol ® D7 | 0.08 | 0.08 | 0.08 | 0.08 | 0.08 | 0.08 | 0.08 | 0.08 | 0.08 |
| Proxel ® GXL | 0.12 | 0.12 | 0.12 | 0.12 | 0.12 | 0.12 | 0.12 | 0.12 | 0.12 |
| Wacker Antifoam ® | 0.5 | 0.1 | 0.1 | 0.1 | 0.1 | 0.1 | 0.1 | 0.1 | 0.1 |
| Atlox ® 4913 | 4.5 | 4.5 | 4.5 | 4.5 | 4.5 | 4.5 | 4.5 | 4.5 | 4.5 |
| Emulsifier PS 54 | 1.5 | 1.5 | 1.5 | 1.5 | 1.5 | 1.5 | 1.5 | 1.5 | 1.5 |
| Glycerol | 10 | 10 | 10 | 10 | 10 | 10 | 10 | 10 | 10 |
| Aerosol ® OTB | 7.5 | | | | | 5 | | | |
| Geropon ® SDS | | 10 | | | 7.5 | | 12.5 | 5 | |
| Lutensol® TO 20 | | | 10 | | | | | | |
| Plurafac ® LF 132 | | | | 10 | | | | | 10 |
| Na benzoate | | | | | | | | | 2 |
| Water | 54 | 52 | 52 | 51.6 | 54.5 | 56.8 | 49.5 | 57 | 50.1 |

Storage Stability of Formulations According to the Invention

To examine the storage stability, 100 ml of formulation were stored under changing temperature conditions (TW) and at 54° C. for eight weeks. The changing temperature conditions are 48 hours at 30° C., reduction of the temperature over 22.5 hours at 2° C./hour to −15° C., 75 hours at −15° C., increase of the temperature over 22.5 hours at 2° C./hour to 30° C. After storage, the sample is brought to room temperature, and dispersibility, particle size and viscosity are checked.

The dispersibility (DISP) is determined according to the CIPAC MT 180 method, the particle size (Part) is measured on a Malvern Mastersizer 2000, and the dynamic viscosity (Visc) is measured at 20 s⁻¹ using a RheoStress RS 150 from Haake.

TABLE 2
Storage stability of formulations according to the invention

| | Initial value | | | 8 weeks at 54° C. | | | 8 weeks TW | | |
|---|---|---|---|---|---|---|---|---|---|
| | DISP | Part | Visc | DISP | Part | Visc | Disp | Part | Visc |
| | in % | in μm | mPas | in % | in μm | mPas | in % | in μm | mPas |
| Exam- | 0.1 | 3.5 | 1416 | 0.1 | 4.8 | 1014 | 0.1 | 3.4 | 2322 |
| ple 1 | | | | | | | | | |
| Exam- | 0.1 | 2.9 | 402 | 0.1 | 6.2 | 480 | 0.1 | 3.8 | 437 |
| ple 2 | | | | | | | | | |
| Exam- | 0.1 | 5.2 | 165 | 0.1 | 7.0 | 151 | 0.1 | 4.3 | 166 |
| ple 3 | | | | | | | | | |
| Exam- | 0 | 4.2 | 527 | 0 | 4.3 | 356 | 0 | 4.0 | 426 |
| ple 4 | | | | | | | | | |
| Exam- | | | | | | | | | |
| ple 5 | | | | | | | | | |
| Exam- | | | | | | | | | |
| ple 6 | | | | | | | | | |
| Exam- | | | | | | | | | |
| ple 7 | | | | | | | | | |
| Exam- | | | | | | | | | |
| ple 8 | | | | | | | | | |
| Exam- | 0.1 | 3.4 | 1697 | | | | | | |
| ple 9 | | | | | | | | | |

### Use Examples

Soil Treatment Trials With Formulations According to the Invention

General description for Examples 1 and 2

Once they have reached to cotyledon stage, evenly grown bell-pepper plants of the cultivar “Feher” are transplanted into 3 litre plastic pots (13.5×13.5×23.5 cm) with natural arable soil or cocoa fibre substrate. After transplantation, the plants are cultivated at 24° C., 70% rel. atmospheric humidity and 12 h of light (Na vapour lamps). Feeding and watering is carried out using one drip tube per pot. Every day, about 3×20 ml of fertilizer solution are applied per pot. The drench solution comprising insecticide or insecticide and adjuvant is applied 29 days after sowing after the fertilizer supply was stopped for a day. The drench solution volume is about 60 ml/pot. The drench solution is applied onto the substrate in circular form around the base of the seedling using a pipette. The drench solution comprises 0.355 mg of imidacloprid/plant. One day after the application of the drench solution, the supply of the plants with water and fertilizer solution is re-established.

As a control, the same test is repeated without addition of a potential adjuvant. For this purpose, a known formulation of imidacloprid (Admire® 2F, Bayer CropScience) is used. When the adjuvants according to the invention are used, this test shows a mortality which is increased compared to that of the control. Here, the mortality is not necessarily increased at each point of time, it may also be that only the initial activity or the long-term activity is improved.

### Example 1

### Myzus Persicae in Arable Soil

To test the activity against Myzus persicae (green peach effect), bell-pepper plants are infected with a mixed population of Myzus persicae (3-leaf stage, 25 days after sowing, 4 days prior to the drench application). For the assessment of how long it takes for the effect to set in, the mortality in % is evaluated 2 and 3 days after the drench application (30-36-day-old plants). The results are listed in Table 3. For the assessment of the persistency, 38 days after the drench application 67-day-old plants are once more inoculated as described above with Myzus persicae, and the mortality is evaluated in % separately for the upper and the lower half of the seedling 7 days after the inoculation. The results are shown in Table 4.

The chosen experimental protocol uses only female aphids which, when they have reached the adult stage, produce a new aphid larva virtually every day. This results in an extremely rapid growth of the aphid population.

The number of aphids which remain on a treated plant is decisive for the re-establishment of the aphid population. As a result, significant differences in the aphid trials in the greenhouse are only found at concentrations which are very low compared to practical applications. The amount of active compound used of 0.355 mg/plant is higher by a factor of 5 than the threshold in the greenhouse trial with standard formulation without adjuvant. Accordingly, a difference of 5% in the activity is significant. Moreover, at efficacies of more than 95%, there are less than 10 aphids on the treated plants; efficacy differences of 5% are clearly recognizable in this range, since, for example, 10 female aphids (90-95% efficacy) can re-establish the population considerably more rapidly than, for example, 2-3 female aphids (>98% efficacy).

TABLE 3

Mortality in %

| | after 2 d | after 3 d |
|---|---|---|
| Without adjuvant | 60 | 94 |
| Example 1 | 73 | 98 |
| Example 2 | 70 | 98 |
| Example 3 | 68 | 99 |
| Example 4 | 68 | 98 |

TABLE 4

Mortality/%

| | Lower | Upper |
|---|---|---|
| | leaves | leaves |
| Without adjuvant | 95 | 95 |
| Example 1 | 98 | 98 |
| Example 2 | 97 | 94 |
| Example 3 | 97 | 99 |
| Example 4 | 100 | 99 |

### Example 2

### Spodoptera Exigua in Arable Soil

To test the activity against Spodoptera exigua (small mottled willow), 20 days after the drench application the third leaf of each bell-pepper plant is cut off, placed into a Petri dish and populated with Spododoptera exigua larvae. After the desired period of time, the effect on the larvae is determined in % mortality. The results are summarized in Table 5.

TABLE 5

| | Mortality/% |
|---|---|
| | 7 d after infection |
| Without adjuvant | 0 |
| Example 1 | 45 |
| Example 3 | 30 |
| Example 4 | 60 |

### Example 3

After sowing, a bell-pepper plant is grown for about 30 days in a 1 litre vessel. The plant is then watered with 60 ml of a solution having the stated concentration of insecticidally active compound and adjuvant and, after the stated period of time, infected with the green peach aphid (Myzus persicae). After the desired period of time, the kill in % is determined. 100% means that all aphids have been killed; 0% means that none of the aphids have been killed. The same test without added adjuvant served as a control.

The results are summarized in Tables 6, 7 and 8.

### Example 4

After sowing, a cabbage plant (Brassica oleracea) is grown for about 14 days in a 1 litre vessel. The plant is then watered with 60 ml of a solution having the stated concentration of insecticidally active compound and adjuvant and, after the stated period of time, infected with the caterpillars of the diamond-back moth (Plutella xylostella). After the desired period of time, the kill in % is determined. 100% means that all caterpillars have been killed; 0% means that none of the caterpillars have been killed. The same test without added adjuvant served as a control.

The results are summarized in Table 9.

### Example 5

After sowing, a cabbage plant (Brassica oleracea) is grown for about 10 days in a 1 litre vessel. The plant is then watered with 60 ml of a solution having the stated concentration of insecticidally active compound and adjuvant and, after the stated period of time, infected with the green peach aphid (Myzus persicae). After the desired period of time, the kill in % is determined. 100% means that all aphids have been killed; 0% means that none of the aphids have been killed. The same test without added adjuvant served as a control.

The results are summarized in Table 10.

In Tables 6 to 10, the mortalities are divided into the following classes:

A—from 0 to 25%

B—from 26 to 50%

C—from 51 to 75%

D—from 76 to 100

TABLE 6

| | | | Point in time | |
|---|---|---|---|---|
| | Adjuvant/ | | when the | |
| Active | concentration | Days from | morality was | |
| compound/ | (mg/l of | application | determined/ | |
| concentration | watering | to | days after | |
| (mg/l of soil) | solution) | infection | infection | Mortality |
| (II-7)/0.0039 | — | 3 | 4 | B |
| (II-7)/0.0039 | (I-5)/2000 | 3 | 4 | D |
| (II-7)/0.0039 | (I-3)/2000 | 3 | 4 | D |
| (II-7)/0.0039 | — | 3 | 7 | C |
| (II-7)/0.0039 | (I-5)/2000 | 3 | 7 | D |
| (II-7)/0.0039 | (I-3)/2000 | 3 | 7 | D |
| (II-7)/0.0039 | (I-2)/1000 | 3 | 7 | D |
| (II-7)/0.0039 | — | 21 | 4 | C |
| (II-7)/0.0039 | (I-5)/2000 | 21 | 4 | D |
| (II-7)/0.0039 | (I-3)/2000 | 21 | 4 | D |
| (II-7)/0.0039 | — | 21 | 7 | C |
| (II-7)/0.0039 | (I-5)/2000 | 21 | 7 | D |
| (II-7)/0.0039 | (I-3)/2000 | 21 | 7 | D |

TABLE 7

| | | | Point in time | |
|---|---|---|---|---|
| | Adjuvant/ | | when the | |
| Active | concentration | Days from | morality was | |
| compound/ | (mg/l of | application | determined/ | |
| concentration | watering | to | days after | |
| (mg/l of soil) | solution) | infection | infection | Mortality |
| (IV-1)/0.0313 | — | 7 | 4 | C |
| (IV-1)/0.0313 | (I-5)/2000 | 7 | 4 | D |
| (IV-1)/0.0313 | (I-3)/2000 | 7 | 4 | D |
| (IV-1)/0.0313 | — | 7 | 6 | C |
| (IV-1)/0.0313 | (I-5)/2000 | 7 | 6 | D |
| (IV-1)/0.0313 | (I-3)/2000 | 7 | 6 | D |
| (IV-1)/0.0156 | — | 13 | 5 | C |
| (IV-1)/0.0156 | (I-5)/2000 | 13 | 5 | D |
| (IV-1)/0.0156 | (I-3)/2000 | 13 | 5 | D |
| (IV-1)/0.0156 | — | 13 | 7 | C |
| (IV-1)/0.0156 | (I-5)/2000 | 13 | 7 | D |
| (IV-1)/0.0156 | (I-3)/2000 | 13 | 7 | D |

TABLE 8

| | | | Point in time | |
|---|---|---|---|---|
| | Adjuvant/ | | when the | |
| Active | concentration | Days from | morality was | |
| compound/ | (mg/l of | application | determined/ | |
| concentration | watering | to | days after | |
| (mg/l of soil) | solution) | infection | infection | Mortality |
| (V-3)/2 | — | 3 | 7 | B |
| (V-3)/2 | (I-5)/1000 | 3 | 7 | C |
| (V-3)/2 | — | 5 | 7 | B |
| (V-3)/2 | (I-5)/1000 | 5 | 7 | C |

TABLE 9

| | | | Point in time | |
|---|---|---|---|---|
| | Adjuvant/ | | when the | |
| Active | concentration | Days from | morality was | |
| compound/ | (mg/l of | application | determined/ | |
| concentration | watering | to | days after | |
| (mg/l of soil) | solution) | infection | infection | Mortality |
| (VI-1)/1 | — | 1 | 7 | A |
| (VI-1)/1 | (I-3)/1000 | 1 | 7 | B |
| (VI-1)/1 | (I-5)/1000 | 1 | 7 | C |
| (VI-1)/5 | — | 1 | 7 | C |
| (VI-1)/5 | (I-3)/1000 | 1 | 7 | D |

TABLE 10

| | | | Point in time | |
|---|---|---|---|---|
| | Adjuvant/ | | when the | |
| Active | concentration | Days from | morality was | |
| compound/ | (mg/l of | application | determined/ | |
| concentration | watering | to | days after | |
| (mg/l of soil) | solution) | infection | infection | Mortality |
| (II-7)/0.0039 | — | 3 | 7 | B |
| (II-7)/0.0039 | (I-2)/1000 | 3 | 7 | C |
| (II-7)/0.00195 | — | 3 | 7 | A |
| (II-7)/0.00195 | (I-2)/1000 | 3 | 7 | B |

1. A method for controlling animal pests or phytopathogenic fungi comprising applying an agrochemical composition comprising at least one agrochemically active compound and applying at least one adjuvant to the culture substrate of a plant.

2. A method according to claim 1, wherein the adjuvant is selected from the group consisting of
dioctyl sodium sulphosuccinate,
compositions comprising dioctyl sodium sulphosuccinate and sodium benzoate,
terminally capped alkoxylated fatty alcohols and terminally capped alkoxylated straight-chain alcohols,
tributylphenol polyglycol ethers having 10 to 15 EO units, where EO means ethylene oxide,
polyalkylene oxide-modified polymethylsiloxanes,
branched alkanol alkoxylates of the formula CH₃—(CH₂)ₜ—CH₂—O—(—CH₂—CH₂—O—)ᵤ—H, in which t represents numbers from 9 to 10.5 and u represents numbers from 6 to 25,
betaine,
polyalkoxylated triglycerides,
alkoxylated fatty amines,
sodium laureth sulphate,
PEG-10 coconut alcohol and
compositions comprising maize syrup, petroleum oil and nonionic emulsifier.

3. Agrochemical composition for use in the soil, comprising
at least one agrochemically active compound,
at least one adjuvant selected from the group consisting of
dioctyl sodium sulphosuccinate,
compositions comprising dioctyl sodium sulphosuccinate and sodium benzoate
terminally capped alkoxylated fatty alcohols and terminally capped alkoxylated straight-chain alcohols
tributylphenol polyglycol ethers having 10 to 15 EO unit, where EO means ethylene oxide,
polyalkylene oxide-modified polmethylsiloxane,
branched alkanol alkoxylates of the formula CH₃—(CH₂)ₜ—CH₂—O—(—CH₂—CH₂—O—)ᵤ—H, in which t represents numbers from 9 to 10.5 and u represents numbers from 6 to 25,
betaine,
polyalkoxylated triglycerides,
alkoxylated fatty amines,
sodium laureth sulphate,
PEG-10 coconut alcohol and
compositions comprising maize syrup, petroleum oil and nonionic emulsifier.

4. A composition according to claim 3, comprising
at least one nonionic surfactant and/or at least one anionic surfactant,
at least one additive selected from the group consisting of antifreeze agents, antifoams, preservatives, antioxidants, spreading agents, colorants and/or thickeners.

5. A composition according to claim 4, comprising
from 1 to 60% by weight of at least one agrochemically active compound selected from group consisting of the classes of the insecticides and fungicides,
from 1 to 50% by weight of at least one adjuvant,
from 1 to 20% by weight of at least one nonionic surfactant and/or anionic surfactant,
from 1 to 20% by weight of antifreeze agent and
from 0.1 to 20% by weight of additives selected from the group consisting of antifoams, preservatives, antioxidants, spreading agents, colorants and/or thickeners.

6. A composition according to claim 5, comprising at least one active compound selected from the group consisting of thiamethoxam, clothianidin, thiacloprid, dinotefuran, acetamiprid, nitenpyram, imidacloprid and the compounds below:

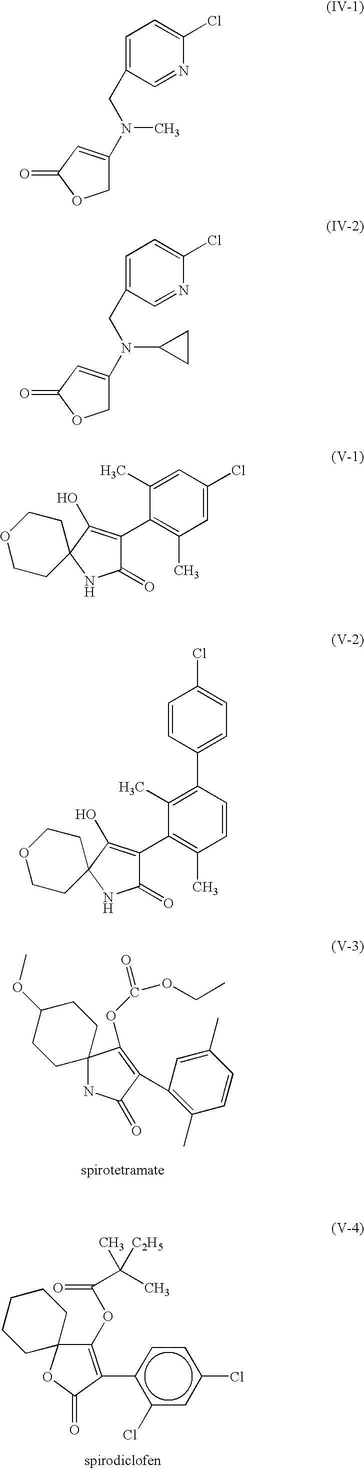

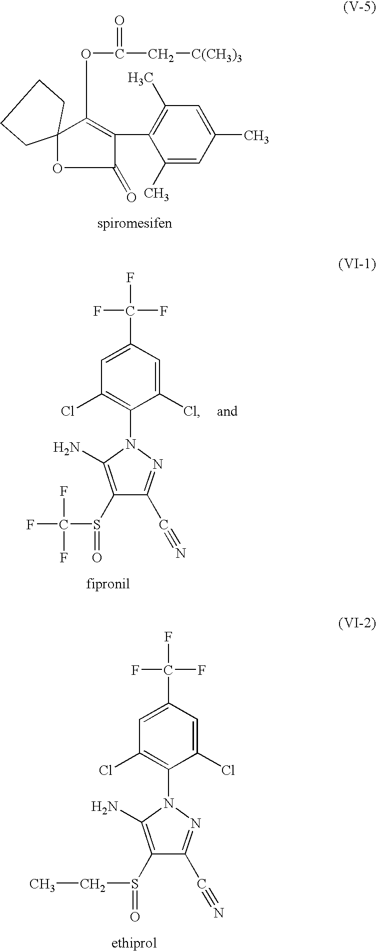

7. A composition according to claim 6, comprising as said active compound, at least one active compound selected from the group consisting of (II-7), (IV-1), (V-3) and (VI-1).

8. A method for improving the action of crop protection agents in soil applications comprising applying at least one adjuvant to soil.

9. A method according to claim 8, wherein said at least one adjuvant is selected from the group consisting of
dioctyl sodium sulphosuccinate,
compositions comprising dioctyl sodium sulphosuccinate and sodium benzoate,
terminally capped alkoxylated fatty alcohols and terminally capped alkoxylated straight-chain alcohols,
tributylphenol polyglycol ethers having 10 to 15 EO units, where EO means ethylene oxide,
polyalkylene oxide-modified polymethylsiloxane,
branched alkanol alkoxylates of the formula CH₃—(CH₂)ₜ—CH₂—O—(—CH₂—CH₂—O—)ᵤ—H, in which t represents numbers from 9 to 10.5 and u represents numbers from 6 to 25,
betaine,
polyalkoxylated triglycerides,
alkoxylated fatty amines,
sodium laureth sulphate,
PEG-10 coconut alcohol and
compositions comprising maize syrup, petroleum oil and nonionic emulsifier.

10. A method according to claim 1, wherein the agrochemically active compound used is imidacloprid and the adjuvant is selected from the group consisting of
terminally capped alkoxylated fatty alcohols and terminally capped alkloxylated straight-chain alcohols,
polyalkylene oxide-modified polymethylsiloxane and
compositions comprising dioctyl sodium sulphosuccinate and sodium benzoate.

11. A method according to claim 1, wherein the agrochemically active compound is the compound of the formula (IV-1) 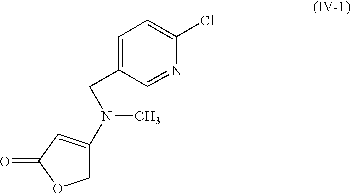
and the adjuvant is selected from the group consisting of
terminally capped alkoxylated fatty alcohols and terminally capped alkoxylated straight-chain alcohols and
polyalkylene oxide-modified polymethylsiloxanes.

12. A method according to claim 1, wherein the agrochemically active compound is spirotetramate and the adjuvant is a polyalkylene oxide-modified polymethylsiloxane.

13. A method according to claim 1, wherein the agrochemically active compound is fipronil and the adjuvant is selected from the group consisting of
terminally capped alkoxylated fatty alcohols and terminally capped alkoxylated straight-chain alcohols and
polyalkylene oxide-modified polymethylsiloxanes.

14. A composition according to claim 3, comprising
imidacloprid and
an adjuvant selected from the group consisting of
terminally capped alkoxylated fatty alcohols and terminally capped alkoxylated straight-chain alcohols,
polyalkylene oxide-modified polymethylsiloxane and
compositions comprising dioctyl sodium sulphosuccinate and sodium benzoate.

15. A composition according to claim 3, comprising the compound of the formula (IV-1) 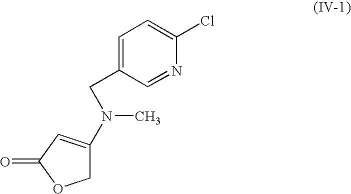
and an adjuvant selected from the group consisting of
terminally capped alkoxylated fatty alcohols and terminally capped alkoxylated straight-chain alcohols and
polyalkylene oxide-modified polymethylsiloxanes.

16. A composition according to claim 3, comprising spirotetramate and polyalkylene oxide-modified polymethylsiloxane.

17. A composition according to claim 3, comprising fipronil and an adjuvant selected from the group consisting of
terminally capped alkoxylated fatty alcohols and terminally capped alkoxylated straight-chain alcohols and
polyalkylene oxide-modified polymethylsiloxanes.

18. A method of claim 1, wherein said composition comprises imidacloprid and/or fipronil, and an adjuvant selected from the group consisting of
terminally capped alkoxylated fatty alcohols and terminally capped alkoxylated straight-chain alcohols,
polyalkylene oxide-modified polymethylsiloxane and
compositions comprising dioctyl sodium sulphosuccinate and sodium benzoate.

19. A method of claim 1, wherein said composition comprises the compound of the formula (IV-1) 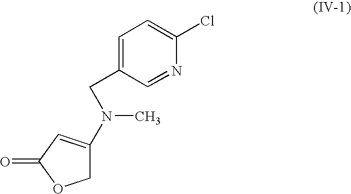
and an adjuvant selected from the group consisting of
terminally capped alkoxylated fatty alcohols and terminally capped alkoxylated straight-chain alcohols and
polyalkylene oxide-modified polymethylsiloxanes.

20. A composition according to claim 4, comprising spirotetramate and polyalkylene oxide-modified polymethylsiloxane.
